(19) United States
(12) Patent Application Publication
(10) Pub. No.: US 2014/0244653 A1
(43) Pub. Date: Aug. 28, 2014

(54) Manual Activity Prioritization

(71) Applicant: Yagi Corp., Concord, MA (US)

(72) Inventor: Robert Plotkin, Concord, MA (US)

(73) Assignee: Yagi Corp., Concord, MA (US)

(21) Appl. No.: 14/187,534

(22) Filed: Feb. 24, 2014

Related U.S. Application Data
(60) Provisional application No. 61/768,500, filed on Feb. 24, 2013.

(51) Int. Cl. G06F 17/30; G06F 7/24

(52) U.S. Cl. CPC G06F 17/30613; G06F 7/24
USPC 707/741

(57) ABSTRACT

A computer system enables a user to manually order messages in a list on a per-message basis. More generally, the system enables data elements of a plurality of types, such as messages, appointments, and tasks, to be combined into a single list, which may be manually ordered by the user on a per-element basis. The system also enables the user to mark any element in a list as complete. The system takes an appropriate action in response to a list element being marked as complete, such as removing the element from the list.

### BACKGROUND

Users of computing devices often use messages (such as email messages, text messages, and voicemail messages) as reminders of actions that the users need to take. For example, users often leave email messages in their email inboxes as reminders to reply to those email messages. Message inboxes, in other words, often double as to-do lists. It is widely acknowledged, however, that message inboxes are not optimal for use as to-do lists. Despite this widespread knowledge, users continue to use message inboxes for this purpose.

### SUMMARY

A computer system enables a user to manually order messages in a list on a per-message basis. More generally, the system enables data elements of a plurality of types, such as messages, appointments, and tasks, to be combined into a single list, which may be manually ordered by the user on a per-element basis. The system also enables the user to mark any element in a list as complete. The system takes an appropriate action in response to a list element being marked as complete, such as removing the element from the list.

Other features and advantages of various aspects and embodiments of the present invention will become apparent from the following description and from the claims.

### BRIEF DESCRIPTION OF THE DRAWINGS

FIG. 1A is a diagram of a list;

FIG. 1B is a diagram of a list including an index set;

FIG. 1C is a diagram of a list containing list elements, each of which contains a plurality of portions;

FIG. 2 is a dataflow diagram of a system for manually ordering a list according to one embodiment of the present invention;

FIG. 3 is a flowchart of a method performed by the system of FIG. 2 according to one embodiment of the present invention;

FIG. 4A is a diagram of a list with corresponding indices according to one embodiment of the present invention;

FIG. 4B is an illustration of a user interface for manually ordering a list according to one embodiment of the present invention;

FIG. 4C is a diagram of the list of FIG. 4A after being manually reordered according to one embodiment of the present invention;

FIG. 5A is a dataflow diagram of a list maintained by a native computer program;

FIG. 5B is a dataflow diagram of a system including a version of the native computer program of FIG. 5A that has been modified to enable it to manually reorder lists according to one embodiment of the present invention;

FIG. 5C is a dataflow diagram of a system including a native computer program and a distinct list management module for manually reordering lists, including lists maintained by the native computer program, according to one embodiment of the present invention;

FIG. 5D is a diagram of a list including references to list elements maintained by a native computer program according to one embodiment of the present invention;

FIG. 6A is a flowchart of a method for automatically incorporating list elements maintained by a native computer program into a list maintained by an embodiment of the present invention;

FIG. 6B is a flowchart of a method for incorporating a list element maintained by a native computer program into a list maintained by an embodiment of the present invention in response to user input;

FIG. 7 is a dataflow diagram of a system for manifesting a list according to one embodiment of the present invention;

FIG. 8 is a flowchart of a method performed by the system of FIG. 7 according to one embodiment of the present invention;

FIGS. 9A-9C are illustrations of user interfaces for manifesting and performing operations on lists according to embodiments of the present invention;

FIGS. 10A-10C are diagrams of lists according to embodiments of the present invention;

FIGS. 11A-11B are dataflow diagrams of systems for performing operations on list elements and lists according to embodiments of the present invention;

FIGS. 12A-12B are flowcharts of methods performed by the systems of 11A-11B according to embodiments of the present invention;

FIG. 13 is a dataflow diagram of a system for enabling a user to mark a list element as complete according to one embodiment of the present invention; and

FIG. 14 is a flowchart of a method performed by the system of FIG. 13 according to one embodiment of the present invention.

### DETAILED DESCRIPTION

Embodiments of the present invention may be used to enable a user to manually reorder data elements in a data set. A “data set,” as that term is used herein, refers to a set of data elements. A “data element,” as that term is used herein, refers to any data structure, in any format, stored on one or more non-transitory computer-readable media. A data element may represent any information, such as a single number (e.g., a single binary number or a single decimal number), an email message, a calendar appointment, or a task (alternatively referred to as a “to-do” or a “reminder”).

A data element has a value. For example, a data element may have a value of the integer 1, a value of the character string “hello,” a value representing the list of integers (1, 2, 3), a value representing the contents of a particular email message, a value representing the contents of a particular calendar appointment, or a value representing the contents of a particular task. The term “contents” herein refers to data and/or metadata. For example, the “contents” of an email message may include any one or more of the following: the body of the email message, the addressee(s) of the email message, the sender of the email message, any attachments to the email message, and the date on which the email message was sent.

The value of a data element may change over time. For example, a particular data element may have a value of 1 at one time, a value of 7 at another time, and a value of 3 at yet another time. The act of changing the value of a data element to a particular value typically is referred to as “assigning” the particular value to the data element.

A data element may have a data type. The data type of a data element may impose restrictions on the range of the data element's values. For example, if a data element has a data type of integer, then the range of the data element's values may include only integers (e.g., a subset of the set of integers). Note that the data types of particular data elements are expressed herein within angled brackets for ease of explanation. Note that particular data type labels used herein, such as integer and character, are intended to be illustrative, not limiting, and do not necessarily correspond to the labels used within any particular programming language or computer program.

The integer data type typically is considered to be a primitive data type, because it cannot be further decomposed into other data types. Other common examples of primitive data types include floating point numbers, Boolean logic values, and characters.

A composite data type (also referred to as a “complex data type” or a “compound data type”) may be composed of at least two component data types, each of which may be a primitive data type or a composite data type. For example, a composite data type may consist of a combination of an integer and a character string. Common examples of composite data types include arrays, records, and unions.

The term “abstract data type” sometimes is used to refer to the data type of a class of data structures that have similar behavior. Common examples of abstract data types include containers, queues, deques, priority queues, lists, maps, multimaps, multisets, sets, stacks, strings, and trees.

In computer science, distinctions sometimes are made between primitive data types which are built in to a particular programming language (such as the <int> type in the C programming language) and primitive data types which are not built in to the programming language but which may be added to programs by programmers using the programming language. Terms such as “built in” data type and “basic” data type may be used to distinguish between primitive data types that are built in to a programming language and those that are not built in to the programming language. These and other distinctions may also be applied to composite data types and abstract data types. No such distinction is made herein, and embodiments of the present invention may be applied to any data type, whether or not it is built in to a particular programming language. In general, the term “data type,” as used herein, should be understood to include primitive data types, composite data types, and abstract data types.

The term “data set,” as mentioned above, refers herein to a set of data elements. A data set may include any number (zero, one, or more) of data elements. A data set may, for example, consist of data elements all having the same data type (e.g., <int> or <char>), or may include some data elements having one data type and other data elements having another data type. More generally, a data set may include any number of data elements, each having any data type.

A data element may be a data set. In other words, the data type of a data element may be a type of data set, such as an array data type or a list data type. For example, a list is a data element and also a data set, because a list data element includes a set of data elements. A data set may include zero, one, or more data elements which themselves are data sets.

Data elements may be added to and/or removed from a data set. The value of a data element in a data set may change over time in any of the ways disclosed herein for individual data elements.

The term “data type” sometimes is used to refer specifically to a data type of a data element within a particular computer program and defined in accordance with a particular programming language. For example, a particular computer program written in the C programming language may include a variable having the name “age” and having a data type of <int>. In this example:
The “age” variable, which is defined within the program according to the C programming language, is a data element within the computer program.
The <int> data type, which is a primitive data type in the C programming language, is a data type within the computer program, and is the data type of the “age” data element.

As used herein, the term “data element” includes, but is not limited to, data elements within a computer program as defined by the programming language in which the computer program is written. Similarly, the term “data type” includes, but is not limited to, data types according to the programming language in which the computer program is written. For example, a particular computer program may use the C programming language to create a particular data element having the name “age” and having a data type of array (e.g., <int[ ]>) in the C programming language). This “age” data element may include a plurality of data elements having the name “person.” Each such “person” data element Pₙ may include two data elements:
a first data element having a name of “ageInYears” and having a data type of <int>, which is intended to represent the age, in years, of a person represented by “person” data element Pₙ; and
a second data element having a name of “sequenceID” and having a data type of <int>, which is intended to represent the index of the “age” data element of “person” data element Pₙ in the “age” data element.

For example, assume that the “age” data element contains the following three “person” data elements:
“person” data element P₀, whose “sequenceID” data element has a value of 2;
“person” data element P₁, whose “sequenceID” data element has a value of 0; and
“person” data element P₂, whose “sequenceID” data element has a value of 1.

Since the values of the “sequenceID” data elements of the “person” data elements in the “age” data element represent the indices of the “person” data elements within the “age” data element, the set of “sequenceID” data elements for all of the “person” data elements may specify a sequence (ordering) of the “person” data elements within the “age” data element. For example, such a sequence may be derived by applying a sorting function to the “sequenceID” data elements of the “person” data elements to produce an ordering of the “sequenceID” data elements, and then mapping the ordered “sequenceID” data elements to their corresponding “person” data elements to obtain the sequence of the “person” data elements. For example, if the sorting function that is applied to the “sequenceID” data elements in an ascending sort function, then the resulting ordering of the “person” data elements is (P_{I}, P₂, P₀), whereas if the sorting function that is applied to the “sequenceID” data elements is a descending sort function, then the resulting ordering of the “person” data elements is (P₀, P₂ P₁).

The “age” data element described above may be manifested to a user of the computer program by manifesting (e.g., displaying) the “person” data elements of the “age” data element in the sequence obtained for the “person” data elements. In other words, the computer program may manifest the “age” data structure to the user in the form of a list. Furthermore, the computer program may enable the “age” data structure to exhibit the behavior of a list, such as by allowing new data elements to be inserted into the list and allowing existing elements to be removed from the list. In this example, although the “age” data structure is implemented using a data structure having a data type of array, such a data structure may exhibit the same or similar behavior as a data structure having a data type of list, at least from the perspective of the computer program's user. Such a data structure is an example of a data element having a data type of list, despite the fact that the data element is implemented within the computer program as a data structure having a data type of array, not a data type of list.

In the example just described:
The “age” data element is implemented internally as a data element having a data type of array. This is an example of what is referred to herein as an “implemented data element.” An implemented data element that is a data set (such as an implemented data element having a data type of array or list) is referred to herein as an “implemented data set.”
The “age” data element is manifested externally to the user as a data element having a data type of list. This external manifestation is an example of what is referred to herein as a “manifested data element.” A manifested data element that is a data set (such as an implemented data element having a data type of array or list) is referred to herein as a “manifested data set.”

Although data elements in an implemented data set may have a one-to-one correspondence with data elements in a corresponding manifested data set, this is not a requirement of the present invention. Alternatively, for example, two or more data elements in an implemented data set may be manifested to produce a single data element in a corresponding manifested data set. As another example, one data element in an implemented data set may be manifested to produce a plurality of elements in a corresponding manifested data set.

Although all data elements in an implemented data set may be manifested to produce a corresponding manifested data set, this is not a requirement of the present invention. Alternatively, only a subset (i.e., some but not all) of the data elements in an implemented data set may be manifested to produce a corresponding manifested data set. As another example, a first subset (i.e., some but not all) of the data elements in an implemented data set may be manifested to produce a first corresponding manifested data set, and a second subset (i.e., some but not all) of the data elements in the implemented data set may be manifested to produce a second corresponding manifested data set, where the first and second subset may or may not be disjoint, and where the first and second corresponding manifested data sets may have the same or different data types as each other.

Now consider a particular implemented data element X having a particular data type, such as array. A subset Y (i.e., some but not all) of the data elements in implemented data element X may exhibit the behavior of a data element having the same or different data type as the data type of implemented data element X. Such a subset is an example of what is referred to herein as an “effective data element.” For example, such a subset may exhibit the behavior of a data element having a data type of list or a data type of array. A first subset (i.e., some but not all) of the data elements in an implemented data set may exhibit the behavior of a first effective data element (e.g., a first effective data set), and a second subset (i.e., some but not all) of the data elements in the implemented data set may exhibit the behavior of a second effective data element (e.g. a second effective data set), wherein the first and second effective data elements may or may not be disjoint, and where the first and second effective data elements may have the same or different data types as each other. Such characteristics may be generalized to any number of subsets of an implemented data set.

As another example, an effective data element may contain the union of two or more data elements, referred to herein as “constituent data elements” of the effective data element. For example, an effective data element may contain the union of: (1) a first data element (e.g., a first data set) or a subset thereof; and (2) a second data element (e.g., a second data set) or a subset thereof. As just one particular example, a effective data element having a data type of list may contain the union of: (1) all data elements from a first data set having a data type of list; and (2) some, but all not, data elements from a second data set having a data type of list. An effective data element may have the same or different data type than any of its constituent data elements. Any two data constituent data elements of an effective data element may have the same or different data type as each other.

The term “data element” as referred to herein includes implemented data elements, manifested data elements, and effective data elements. Although in the particular example above the implemented data element has a different data type than the corresponding manifested data element, this is merely an example and does not constitute a limitation of the present invention. Alternatively, for example, an implemented data element may have the same data type as a corresponding manifested data element.

A particular implemented data element that is manifested to produce a particular manifested data element is said herein to “correspond” to the particular manifested data element. Therefore any reference herein to a particular implemented data element and a “corresponding” manifested data element, or vice versa, should be understood accordingly. A particular implemented data element may be manifested as one or more manifested data elements. A particular implemented data element, therefore, may correspond to one or more manifested data elements. If a particular implemented data element corresponds to a plurality of manifested data elements, any two such manifested data elements may have the same or different data types as each other. For example, an implemented data element having a data type of array may be manifested as a first manifested data element having a data type of list and be manifested as a second manifested data element having a data type of array.

As used herein, “manifesting” data refers to providing output, to a user, that represents such data. Such output may take any form, such as a visual form and/or an auditory form. For example, such output may include any one or more of the following in any combination: text, graphics, images, video, and audio. As this description makes clear, any output described herein as being “manifested,” may, for example, solely include text, solely include graphics, solely include video, or solely include audio.

References are made herein to the value “of” a data element and to a data element “having” a value. The value of a data element may, however, be a reference (e.g., pointer) to another data element. For ease of illustration, consider a data element X that is implemented using a variable having a data type of <double> in the C programming language. Reference herein to the value “of” data element X may refer to the value of the <double> variable. This value is an example of what is referred to herein as a “direct” value of the <double> variable.

The value of the <double> variable may, however, be treated as a reference to an address of another data element Y having, for example, a data type of <int> in the C programming language. Reference herein to the value “of” data element X may, therefore, refer to the <int> value of data element Y. This value is an example of what is referred to herein as an “indirect” value of the <double> variable. References herein to the value “of” a data element and to a data element “having” a value include both direct and indirect values of the data element. Although in the example above the reference is implemented using a pointer in the C programming language, this is merely an example and does not constitute a limitation of the present invention. More generally, such a reference may be implemented in any manner, including using mechanisms (such as HTML hyperlinks) not provided natively by a computer programming language.

Similarly, references are made herein to data sets “including,” “containing,” or “having” data elements. Any reference herein to a data set X “including,” “containing,” or “having” a data element Y should be understood to mean that data set X may incorporate data element Y, or data derived therefrom (such as a notification of data element Y), by value or by reference. Furthermore, any references herein to “removing” or “deleting” a data element from a data set include implementations in which the data element is erased from the data set and implementations in which the data element is marked as deleted (such as by changing the value of a “deleted” flag associated with the data element) even though the data element otherwise remains unchanged.

The term “data element,” as used herein, includes, but is not limited to, any of the data elements described above. For example, the term “data element,” as used herein, includes data elements having primitive data types, data elements having composite data types, and data elements having abstract data types. As another example, the term “data element,” as used herein, includes implemented data elements and manifested data elements.

Embodiments of the present invention may be used to enable a user to manually reorder data elements in a list. As indicated by the discussion above, a list may be an implemented list data element (e.g., a data element implemented using a primitive list data type in a programming language such as LISP), a manifested data element, or an effective data element.

As is well-known to those having ordinary skill in the art, a list is an ordered sequence of data elements, where the ordering of the data elements may be implemented in any of a variety of ways. For example, a list may be implemented as a linked list, such as a singly-linked list (in which each data element includes a link to its immediate successor or its immediate predecessor) or a doubly-linked list (in which each data element includes a link both to its immediate successor and to its immediate predecessor). These are merely examples and do not constitute limitations of the present invention. Rather, in general, the term “list” herein refers to any data element that exhibits the behavior of a list.

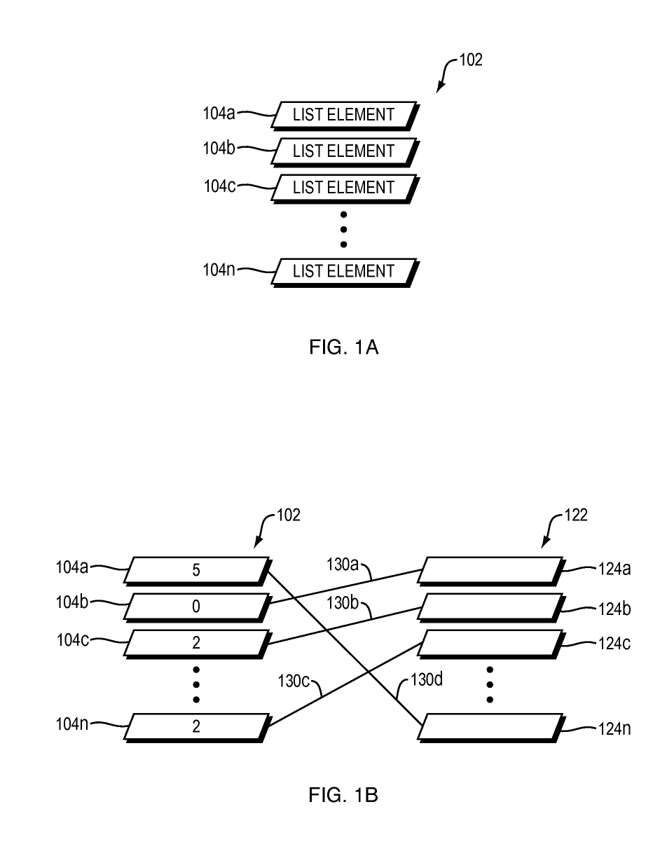

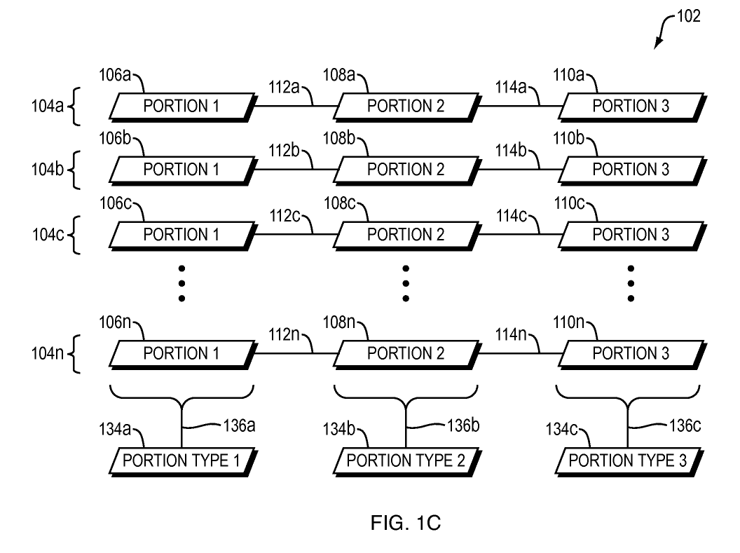

For ease of illustration and explanation, lists will be illustrated and described herein as shown by the generic list 102 in FIG. 1A. The list 102 contains a plurality of data elements 104a-n (also referred to herein as “list elements”). Although four list elements 104a, 104b, 104c, and 104n are shown in FIG. 1A for purposes of example, a list may include any number of elements (including zero). The value of n may, therefore, be any non-negative integer. Each of the list elements 104a-n is an example of a “data element,” as that term is used herein.

A “list,” as that term generally is used in computer science, refers to an ordered data set, such that every data element in the data set has precisely one index that is unique within the data set. (The data elements in a list are also referred to herein as “list elements.”) The transitive relation holds over all of the list elements' indices, such that the order of all of the list's elements is unambiguous. For example, consider the list (B, F, A). In this case, the index of element B may be 0, the index of element F may be 1, and the index of element A may be 2. Lists having the properties described in this paragraph are examples of “lists” as that term is used herein.

The indices of a list's elements may be stored explicitly as index values. For example, in the case of the list (B, F, A), above, the index values (0, 1, 2) may be stored in a computer-readable medium in the same data element as the list (B, F, A) (e.g., as a list of tuples ((B, 0), (F, 1), (A, 2))), or in a different data element than the list (B, F, A), but in a way that associates the list (B, F, A) with its indices (0, 1, 2) (such as by storing, in association with each of the indices, a reference to the corresponding list element). A set of indices, stored in any of the ways described, is one example of what is referred to herein as “list sequence data.”

FIG. 1B shows an illustrative example, in which example values of list elements 104a-n are shown. In particular, list elements 104a-n have values 5, 0, 2, and 2, respectively. In the example of FIG. 1B, a separate list 122 contains list elements 124a-n containing references to corresponding ones of the list elements 104a-n, respectively.

The separate list 122 is an example of an “index set” as that term is used herein, because the order of the list 122's elements 124a-n (namely the order 124a, 124b, 124c, 124d) specifies the order of the elements in the list 102. (Perhaps unfortunately, a list such as the list 122 is sometimes itself referred to in the art as an “index” into the list 102. To avoid confusion, the list 122 will be referred to herein as an “index set.”) The index set 122 is an example of “list sequence data,” as that term is used herein. Therefore, any disclosure herein of properties of an index set is equally applicable to list sequence data more generally.

In the example of FIG. 1B, each of the elements 124a-n in index set 122 contains a reference to a corresponding element in the list 102. In particular, list element 124a includes a reference 130a to list element 104b; list element 124b includes a reference 130b to list element 104c; list element 124c includes a reference 130c to list element 104n; and list element 124n includes a reference to list element 104a. More specifically:
list element 124a is the first element in list 122 and refers to list element 104b in list 102, thereby specifying that list element 104b is the first element in list 102 with respect to index set 122;
list element 124b is the second element in list 122 and refers to list element 104c in list 102, thereby specifying that list element 104c is the second element in list 102 with respect to index set 122;
list element 124c is the third element in list 122 and refers to list element 104n in list 102, thereby specifying that list element 104c is the third element in list 102 with respect to index set 122; and
list element 124n is the last element in list 122 and refers to list element 104a in list 102, thereby specifying that list element 104a is the last element in list 102 with respect to index set 122.

The list 122 (which may include the references 130a-n) may be created and stored, and thereby used to apply the ordering of the list 102 (such as in a process of manifesting the list 102 in the order specified by index set 122) without modifying the list 102 itself. As another example, the index set 122, or data derived therefrom, may be added to the list 102, such as by adding the elements 124a-n and/or references 130a-n into distinct fields within the list elements 104a-n.

As described above, a list has a particular order (also referred to herein as the list's “sequence” or “ordering”). For example, in FIG. 1B, the elements of the list 102 are ordered (with respect to index set 122) in ascending order of their values, namely in the order (0, 2, 2, 5). A list's order may, however, change over time. For example, a sorting (ordering) function may be applied the list elements 104a-n to change the list 102's order. Many sorting techniques are well-known to those having ordinary skill in the art. Embodiments of the present invention may use any sorting technique to sort elements in list 102.

For example, if a descending sorting function were applied to the list 102, the resulting order (sequence) of the list 102 may be the following: 104a, 104c, 104n, 104b, in which case the elements 124a-n of the index set 122 would point to elements 104a, 104c, 104n, and 104b, respectively. Note that in the case of list elements having equivalent values (e.g., in the case of list elements 104c and 104n in FIG. 1B), any of a variety of techniques may be used to order such list elements with respect to each other.

As is well-known to those having ordinary skill in the art, the act of applying a sorting function to the list 102 may or may not cause any modification to the list 102 itself. For example, applying a sorting function to the list 102 may involve only modifying the index set 122, but not modifying the list elements 104a-n. The same is true of any modification to the list 102, such as changing the order of a subset of the list 102, adding elements to the list 102, and deleting elements from the list 102.

Performing operations on the list 102 (such as changing the order of some or all of the list 102, adding elements to the list 102, and deleting elements from the list 102) may, however, involve modifying the list 102 itself, such as by moving list elements 104a-n within the list 102, modifying references among list elements in the list 102 (as in the case of a linked list), adding elements into the list 102, deleting elements from the list 102, or creating a new list that reflects the desired changes to the list 102 and deleting the old list 102.

In the particular example of FIG. 1B, each element in the list 102 has one and only one index. As the term “list” is used herein, however, each element in a list may have one or more indices. Each index may be associated with an index set identifier, which may take any form. For example, consider again the list (B, F, A). Assume that such a list is associated with a first index set (0, 1, 2), having a first unique index set identifier of 0, and a second index set (2, 0, 1), having a second unique index set identifier of 1. The first index set specifies the list order (B, F, A), while the second index set specifies the list order (F, A, B). In the case of a list having multiple index sets, it is not proper to refer to “the” order of the list; rather, reference should be made to “an” order of the list, or to “the” order of the list with respect to particular specified list sequence data (e.g., a particular specified index set). For example, the order of the list (B, F, A) with respect to index set 1 in the example above is (F, A, B).

Furthermore, an index set associated with a “list,” as that term is used herein, may include indices for fewer than all of the list's elements. If an index set associated with a list includes indices for fewer than all of the list's elements, then the order of the list is not uniquely determined, in which case the index set may constitute an input to an ordering procedure that produces (possibly, but not necessarily, deterministically), as output a unique index for all of the list's elements. The resulting unique indices may either replace the input index set or be stored as an additional index set, without causing any modifications to the input index set. Examples of such ordering procedures include:
assigning the corresponding index in the index set to each list element that has a corresponding index in the index set, and inserting the remaining (non-indexed) list elements at the bottom of the list (and assigning indices to those list elements accordingly);
assigning the corresponding index in the index set to each list element that has a corresponding index in the index set, and inserting the remaining (non-indexed) list elements at the top of the list (and reassigning indices to list elements accordingly); and
assigning the corresponding index in the index set to each list element that has a corresponding index in the index set, and not assigning any indices (or assigning null indices) to the remaining (non-indexed) list elements.

In the example of FIG. 1B, the list 102 is sorted according to the entire value of each of the list elements 104a-n. Alternatively, and as is well-known to those having ordinary skill in the art, the list 102 may be sorted based only on a portion of each of the list elements 104a-n.

For example, referring to FIG. 1C, an example embodiment of the list 102 is shown, in which each of the list elements 104a-n includes a plurality of portions. In particular, list element 104a contains portions 106a, 108a, and 110a; list element 104b contains portions 106b, 108b, and 110b; list element 104c contains portions 106c, 108c, and 110c; and list element 104n contains portions 106n, 108n, and 110n.

Each portion within a particular list element may be associated with a corresponding data element portion type. For example, in the embodiment illustrated in FIG. 1C, portions 106a-n are associated 136a with a first portion type 134a; portions 108a-n are associated 136b with a second portion type 134b; and portions 110a-n are associated 136c with a third portion type. As one example, the list 102 may be implemented as a table in a database, in which case each of the list elements 104a-n may be implemented as a distinct row in the table, and each of the portion types 134a-c may correspond to a distinct column in the table.

A sorting function may be applied to a particular one of the portion types 134a-c, thereby causing the list 102 to be sorted by the values of the list element portions associated with the particular one of the portion types 134a-c. In database terminology this is referred to as using the particular one of the portion types 134a-c as a primary sort key. For example, if a sorting function is applied to portion type 134a, the sorting function may sort the list elements 104a-n according to the values of list element portions 106a-n (which are associated with portion type 134a). As is well-known to those having ordinary skill in the art, a sorting function may sort the list 102 using any number of portion types in any of a variety of manners, such as by using one of the portion types as a primary sort key and by using another one of the portion types as a secondary sort key. Embodiments of the present invention may use any such sorting technique and are not limited to using any particular sorting technique to sort the list 102 or any other list disclosed herein.

As shown in FIG. 1C, the portions within a list element may be associated with each other. For example:
in list element 104a, portion 106a is associated 112a with portion 108a, and portion 108a is associated 114a with portion 110a;
in list element 104b, portion 106b is associated 112b with portion 108b, and portion 108b is associated 114b with portion 110b;
in list element 104c, portion 106c is associated 112c with portion 108c, and portion 108c is associated 114c with portion 110c; and
in list element 104n, portion 106n is associated 112n with portion 108n, and portion 108n is associated 114n with portion 110n.

Such associations 112a-n and 114a-n may be implemented in any of a variety of forms. For example, any one or more of such associations 112a-n and 114a-n may be stored as a data element on a non-transitory computer readable medium, such as a pointer from one list element portion to another. As another example, any one or more of such associations 112a-n and 114a-n may be implicit and therefore not stored as a data element on a non-transitory computer readable medium, such as in a case in which two associated portions are two fields in a single database record.

Distinct portions of a particular list element may be:
stored in the same or different data elements as each other;
stored on the same or different non-transitory computer-readable media as each other;
maintained by the same or different computer programs (e.g., operating systems or application programs) as each other.

For example, a first portion of a list element (e.g., portion 106a of list element 104a) may be maintained by a first computer program and stored on a first computer-readable medium, while a second portion of the same list element (e.g., portion 108a of list element 104a) may be maintained by a second computer program and stored on a second computer-readable medium.

Although in the example of FIG. 1C, each of the list elements 104a-n has portions corresponding to all of the portion types 134a-c, this is merely an example and does not constitute a limitation of the present invention. Alternatively, for example, one list element in a list may contain a first portion associated with a first portion type, and a second list element in the same list may not contain any portion associated with the first portion type.

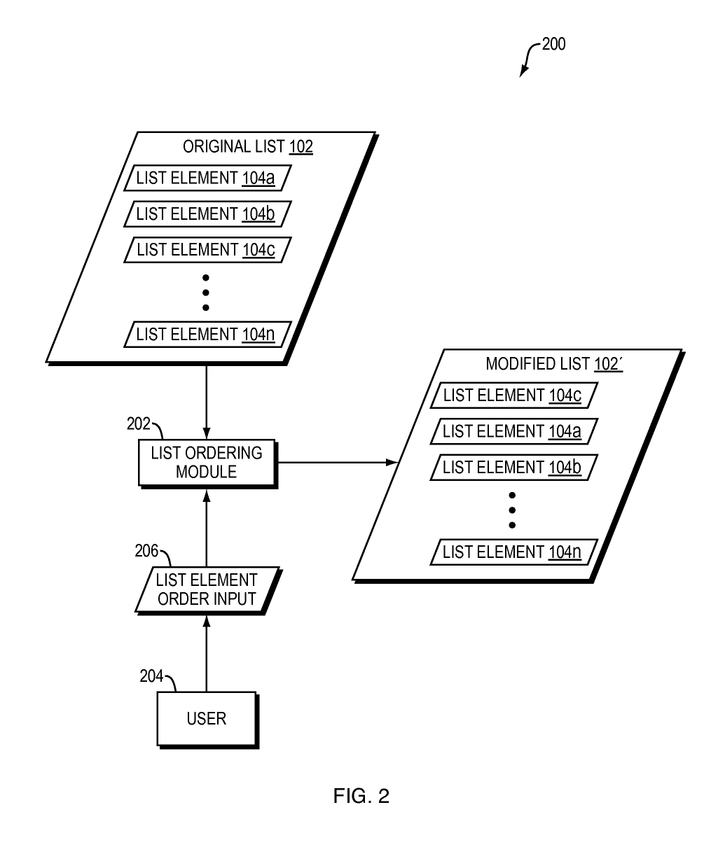

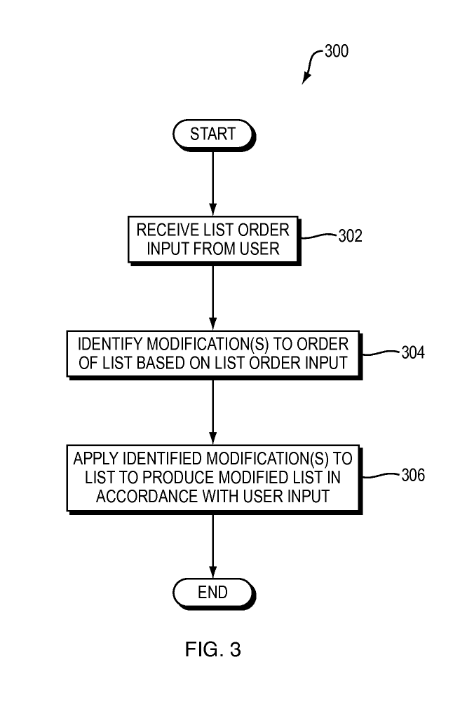

As mentioned above, embodiments of the present invention may be used to enable a user to provide manual input that is used to reorder some or all of the elements in a list. Referring to FIG. 2, a dataflow diagram is shown of a system 200 for enabling a user 204 to manually reorder a list, such as list 102, according to one embodiment of the present invention. Referring to FIG. 3, a flowchart is shown of a method 300 performed by the system 200 of FIG. 2 according to one embodiment of the present invention.

The system 200 includes list 102 for purposes of example. More generally, the system 200 may be used in connection with any list. The system 200 also includes a list ordering module 202. A user 204 of the system 200 provides list element order input 206 to the system 200. In general, the list element order input 206 specifies an order (e.g., index) of some or all of the elements 104a-n in the list. The list ordering module 202 receives the list element order input 206 (FIG. 3, operation 302).

The list ordering module 202 identifies one or more modifications to the order (e.g., index) of some or all of the elements 104a-n of the list 102 based on and in response to the list element order input 206 (FIG. 3, operation 304). The list ordering module 202 applies the identified modification(s) to the list 102, thereby modifying the order (e.g., index) of some or all of the elements 104a-n of the list, and thereby producing a modified list 102′ in which the elements 104a-n are ordered according to the modification(s) applied by the list ordering module 202 (FIG. 3, operation 306). Solely for purposes of example, the modified list 102′ is shown in FIG. 2 as having the first three list elements in the modified order 104c, 104a, 104b.

As shown in FIG. 2, the modified list 102′ may be created by the list ordering module 202 and stored distinctly from the original list 102. Alternatively, for example, the modified list 102′ of FIG. 2 may represent the result of modifying the original list 102 according to the user input 206. In other words, in operation 306 the list ordering module 202 need not create and store a list in addition to the original list 102, but may merely modify the original list 102, whereby the modified list 102′ in FIG. 2 represents the resulting modified version of the original list 102.

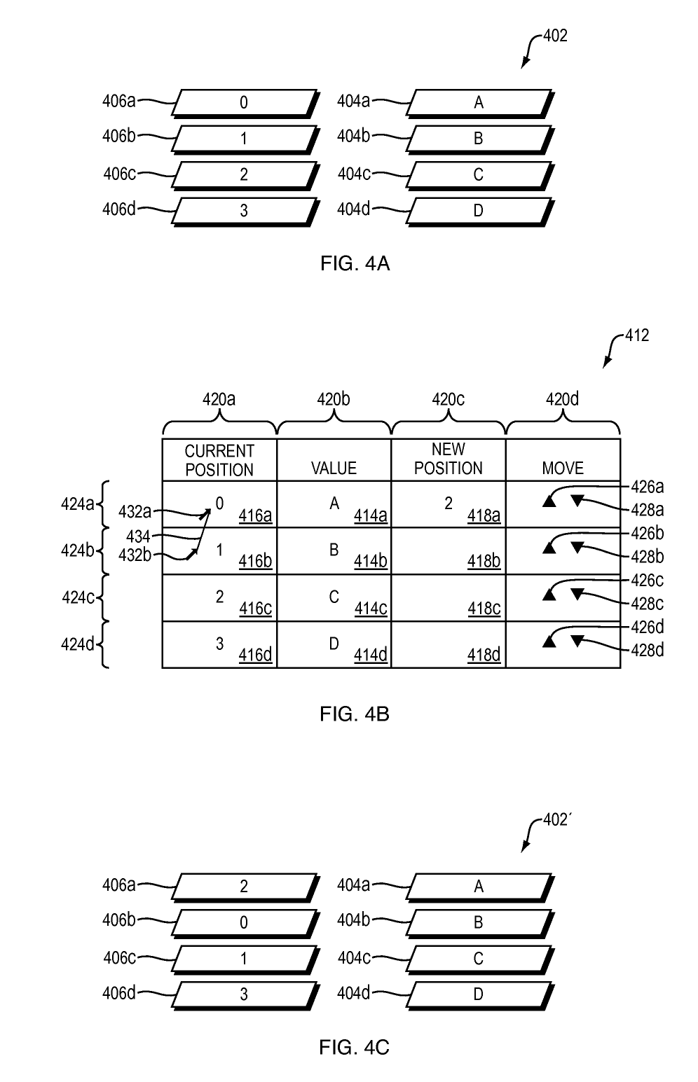

The list element order input 206 provided by the user 204 may take any of a variety of forms. For example, the input 206 may specify, for each of one or more elements 104a-n in the list 102, an index of that element in the list 102. In response to and based on such input, the list ordering module 202 may assign, to each list element specified by the input 206, an index specified by that input, and change the indices of other elements in the list 102 accordingly. For example, consider FIG. 4A, which illustrates a simple list 402 for purposes of example. The list 402 contains four elements 404a-d, having values of A, B, C, and D, respectively. Furthermore, the list elements 404a-d have indices 406a-d within the list 402 of 0, 1, 2, and 3, respectively.

Now assume that the user 204 provides input 206 specifying that list element 404a should be assigned an index of 2. For example, referring to FIG. 4B, the system 200 may display to the user 204 a table 412 representing the list 402. The table 412 is a “manifestation” of the list 402, as the term “manifestation” is used herein. More specifically, the table 412 may include rows 424a-d representing list elements 404a-d, respectively. The table includes column 420a representing the current index of each list element, column 420b representing the value of each list element, and column 420c for receiving user input 206. More specifically:
cell 416a displays the current index of list element 404a;
cell 416b displays the current index of list element 404b;
cell 416c displays the current index of list element 404c;
cell 416d displays the current index of list element 404d;
cell 414a displays the value of list element 404a;
cell 414b displays the value of list element 404b;
cell 414c displays the value of list element 404c; and
cell 414d displays the value of list element 404d.

The user 204 may provide input 206 into the cells 418a-d of column 420c to specify the desired new index of one or more of corresponding list elements 404a-d, respectively. More specifically, the user 204 may input a desired index of element 404a in cell 418a; a desired index of element 404b in cell 418b; a desired index of element 404c in cell 418c; and a desired index of element 404d in cell 418d. Although not shown in FIG. 4B, the system 200 may initially display all of the cells 418a-d as empty cells. FIG. 4B illustrates a particular example in which the user 204 has input the text “2” into cell 418a, thereby indicating that the user 204 desires to change the index of list element 404a to 2. As further illustrated in FIG. 4B, the user 204 may leave one or more of the cells 418a-d empty.

The text “2” in cell 418a of FIG. 4B is an example of the list element order input 206 of FIG. 2. In response to receiving the input text in cell 418a (and possibly also in response to the user 204 pressing an “update” button 430), the list ordering module 202 may order the list 402 in accordance with the input 206 and thereby produce a modified list. For example, the list ordering module 202 may move element 404a to position 2 and move element 404c to position 0, thereby satisfying the user's instruction to place element 404a at position 2 by swapping element 404a with element 404c.

As another example, and as shown in FIG. 4C, the list ordering module 202 may modify the order of the elements 404a-d in the list 402 in accordance with the user input 204 by treating the text “2” in cell 418a as an instruction to insert element 404a between the element that is currently at index 2 (i.e., element 404c) and the element that is currently at index 3 (i.e., element 404d), by changing the index of element 404a to 2 and by decrementing the index all elements at position 2 and lower. The modified list 402′ of FIG. 4C shows the results of reordering the list 402 in this manner.

As even this simple example illustrates, the list ordering module 202 may interpret the user input 206 in any of a variety of ways, and embodiments of the present invention are not limited to any particular such way. Furthermore, the list ordering module 202 may use any of a variety of well-known techniques in the event of an index conflict resulting from the user input 206, such as in the event that the user input 206 specifies or implies the same index for two or more list elements.

The particular method for receiving user input 206 illustrated by column 420c is merely an example and does not constitute a limitation of the present invention. Another example is illustrated by column 420d, which provides up arrows 426a-d and down arrows 428a-d in each of the rows 424a-d corresponding to the list elements 404a-d, respectively. To decrement the index of a particular list element, the user 204 may provide input indicating that the index of the particular list element should be decremented, such as by pressing the up arrow in the row representing the particular list element, in response to which the list ordering module 202 may swap the particular list element with the immediately-preceding list element, thereby producing a modified list. Similarly, to increment the index of a particular list element, the user 204 may provide input indicating that the index of the particular list element should be incremented, such as by pressing the down arrow in the row representing the particular list element, in response to which the list ordering module 202 may swap the particular list element with the immediately-following list element, thereby producing a modified list.

As yet another example, the user interface of FIG. 4B may allow the user 204 to provide the user input 206 by dragging (e.g., using a mouse, other pointing device, or finger) one of the rows 424a-d in the table to a new position. For example, FIG. 4B illustrates an example in which the user 204 has dragged a mouse cursor from a starting point 432a within row 424a along a trajectory 434 to an ending point 432b within row 432b. Such a drag input is an example of the list element order input 206. The list ordering module 202 may interpret (in operation 304) such input as, for example, an instruction by the user 204 to swap list elements 404a and 404b, or to insert element 404a between elements 404b and 404c. In any case, the list ordering module 202 may perform the identified modification(s) to the list 402 to produce a modified list.

Although not shown in the drawings, in any of the examples above, after the list ordering module 202 has created the modified list 102′ (e.g., modified list 402′) based on the user input 206, the system may manifest the modified list 102′ to the user 204, such as by using the user interface of FIG. 4B, and thereby allow the user 204 to view the results of the reordering and to perform further manual reorderings of the list 102′ if desired.

The particular techniques disclosed herein for receiving the list element order input 206 from the user 204 are merely examples and do not constitute limitations of the present invention. Rather, embodiments of the present invention may be used in connection with any kind of list element order input 206 provided by the user 204, via any input device, via any user interface, and taking any form.

Embodiments of the present invention may be used to enable a user to manually reorder any of a variety of data. Examples of such data include messages (such as email messages, text messages, fax messages, and social networking messages), calendar appointments, tasks (also referred to as “reminders” or “to-dos”), and notifications of any of the above.

For example, a list (e.g., list 102 or 402) that is reordered by embodiments of the present invention may solely contain data elements created by, modified by, maintained by, or otherwise associated with a particular computer program (e.g., a particular operating system or application program), such as a particular messaging program (e.g., Microsoft Outlook, Apple Mail, Apple Messages, or Skype), a particular calendar program (e.g., Microsoft Outlook or Apple Calendar), a particular task management program (e.g., Microsoft Outlook or Apple Reminders), a particular notification program (e.g., the Apple Notification Center), or a particular account (e.g., a particular Microsoft Windows Live account, a particular Apple iCloud account, a particular Google Gmail or Google Apps account, or a particular Facebook account).

As another example, a list (e.g., list 102 or 402) that is reordered by embodiments of the present invention may solely contain data elements having a particular data type (such as a message (e.g., email or text message) data type, a calendar appointment data type, a task data type, or a notification data type), where such data elements may include data elements created by, modified by, maintained by, or otherwise associated with more than one computer program (e.g., more than one operating system and/or application program), with more than one account, or with both more than one computer program and more than one account.

For example, a list that is reordered by embodiments of the present invention may solely contain messages, where such messages may include both:
messages created by, modified by, maintained by, or otherwise associated with a first messaging program (e.g., Microsoft Outlook); and
messages created by, modified by, maintained by, or otherwise associated with a second messaging program (e.g., Apple Mail) that differs from the first messaging program.

For example, a list that is reordered by embodiments of the present invention may solely contain calendar appointments, where such calendar appointments may include both:
calendar appointments created by, modified by, maintained by, or otherwise associated with a first calendar program (e.g., Microsoft Outlook); and
calendar appointments created by, modified by, maintained by, or otherwise associated with a second calendar program (e.g., Apple Calendar) that differs from the first calendar program.

For example, a list that is reordered by embodiments of the present invention may solely contain tasks, where such tasks may include both:
tasks created by, modified by, maintained by, or otherwise associated with a first tasks management program (e.g., Microsoft Outlook); and
tasks created by, modified by, maintained by, or otherwise associated with a second task management program (e.g., Apple Reminders) that differs from the first task management program.

For example, a list (e.g., list 102 or 402) that is reordered by embodiments of the present invention may solely contain data elements created by, modified by, maintained by, or otherwise associated with a particular computer program (e.g., a particular operating system or application program), such as a particular messaging program (e.g., Microsoft Outlook or Apple Mail), a particular calendar program (e.g., Microsoft Outlook or Apple Calendar), a particular task management program (e.g., Microsoft Outlook or Apple Reminders), a particular notification program (e.g., the Apple Notification Center), or a particular account (e.g., a particular Microsoft Windows Live account, a particular Apple iCloud account, a particular Google Gmail or Google Apps account, or a particular Facebook account).

As another example, a list (e.g., list 102 or 402) that is reordered by embodiments of the present invention may solely contain data elements having a particular data type (such as a message data type, a calendar appointment data type, a task data type, or a notification data type), where such data elements may include data elements created by, modified by, maintained by, or otherwise associated with more than one computer program (e.g., more than one operating system and/or application program), with more than one account, or with both a computer program and an account.

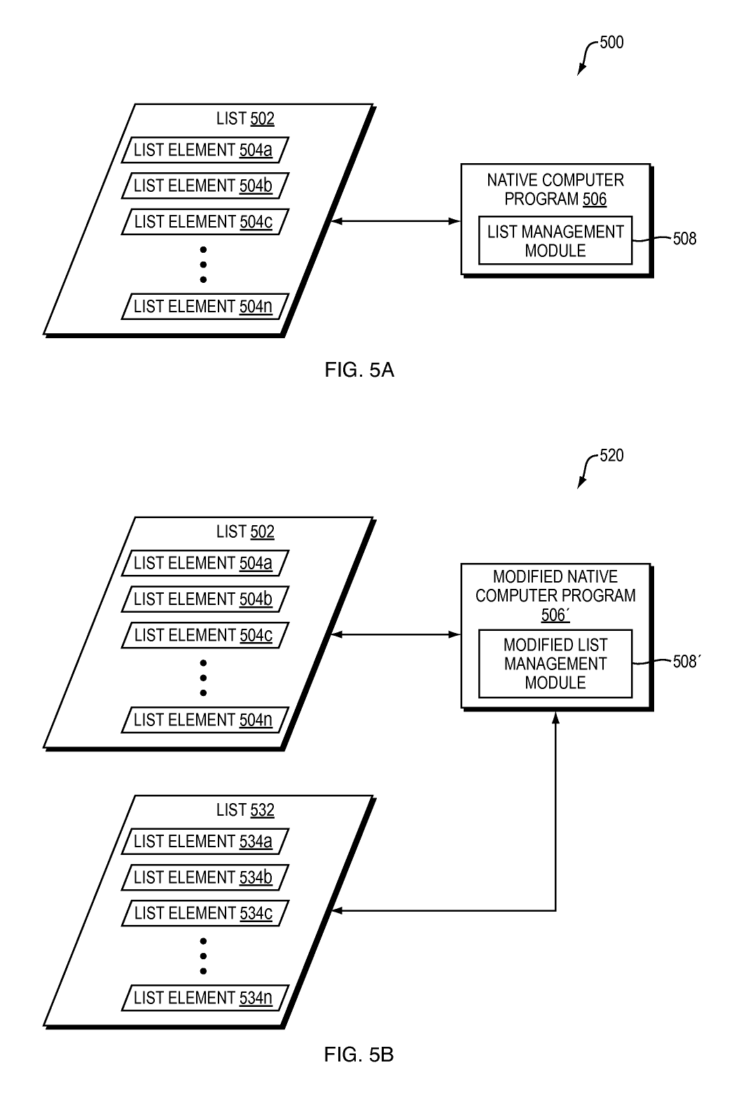

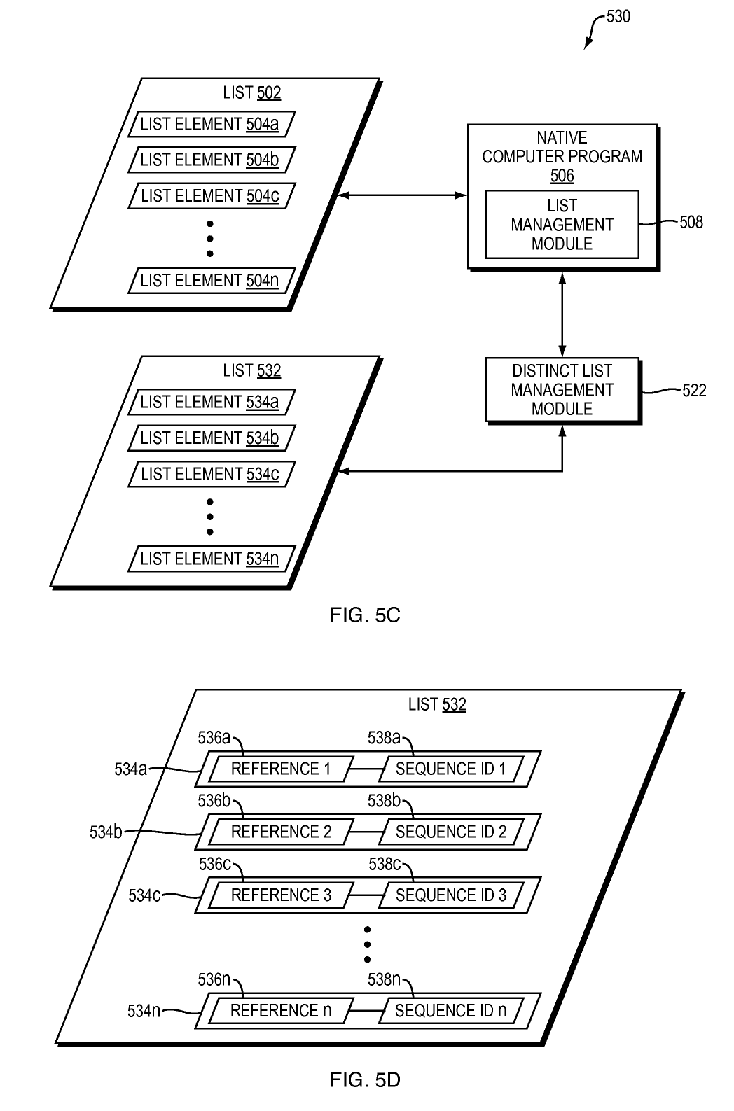

The computer program that creates a data element is referred to herein as the “native” computer program of the data element. For example, if a particular email program (e.g., Microsoft Outlook or Apple Mail) creates a particular email message, then the particular email program is the “native” computer program of the particular email message. For example, consider the prior art system 500 of FIG. 5A, which contains a prior art native computer program 506 (such as Microsoft Outlook or Apple Mail). The native computer program 506 creates and otherwise manages a list 502 of data elements 504a-n, such as a list of email messages (e.g., a user's email inbox). The native computer program 506 includes a list management module 508, which may be any portion of the native computer program 506 that performs functions such as creating, modifying, deleting, and reordering the list 502.

Embodiments of the present invention may be integrated with such a native computer program 506 to reorder lists, such as the list 502, containing data elements created by the native computer program 506. For example, as illustrated by the system 520 of FIG. 5B, the native computer program 506 may be modified, such as by modifying the list management module 508 to enable the list management module 508 to perform the functions disclosed herein (particularly performing the method 200 of FIG. 2), thereby producing a modified native computer program 506′ containing a modified list management module 508′.

For example, embodiments of the present invention may be integrated with a particular email program (e.g., Microsoft Outlook or Apple Mail) by modifying such an email program to include the functionality disclosed herein. More generally, the approach illustrated by FIG. 5B may be applied to a plurality of native computer programs to produce a plurality of modified native computer programs. For example, an embodiment of the present invention may be integrated with a native email program to reorder email messages, with a native calendar program to reorder calendar appointments, with a native task management program to reorder tasks, and with a native notification program to reorder notifications. If a particular native program (such as Microsoft Outlook) is a native program for a plurality of types of data elements (such as email messages, calendar appointments, and tasks), then embodiments of the present invention may be integrated with such a native program to reorder separate lists for each of the plurality of types of data elements, and/or to reorder a single list containing data elements of multiple types.

As another example, embodiments of the present invention may be implemented in one or more computer programs that interoperate with a native computer program to perform the functions disclosed herein. For example, as illustrated by the system of FIG. 5C, functions disclosed herein may be implemented in a distinct list management module 522, which may be implemented as a computer program that is distinct from the native computer program 506, and that is capable of performing, for example, the list reordering method 200 of FIG. 2.

The distinct list management module 522 may, for example, be implemented to interoperate with the native computer program 506 using any one or more of the following techniques:
by implementing the distinct list management module 522 as a plug-in to the native program 506, and which communicates with the native program 506 via a plug-in interface;
by implementing the distinct list management module 522 as a computer program that is distinct from the native computer program 506 and which communicates with the native computer program 506 using an application program interface (API) exposed by the native computer program 506;
by implementing the distinct list management module 522 as a computer program that is distinct from the native computer program 506 and which communicates with the native computer program 56 using a mechanism provided by the operating system on which both the native program 506 and the distinct list management module 522 operate, such as a clipboard mechanism; and
by implementing the distinct list management module 522 as a computer program that is distinct from the particular native program 506, which may execute on a separate virtual machine (e.g., operating system) than the native computer program 506, and that may communicate with the native computer program 506 over a network using, e.g., web services.

Embodiments of the present invention may use any such mechanism(s) to perform any one or more of the following functions:
obtain data from the native computer program 506 about data elements managed by the native computer program 506 (e.g., data elements in list 502), and thereby to create one or more lists 532 of such data elements (where any particular data element in the list 532 may be a copy of or a reference to the corresponding data element in the native computer program's list 502);
obtain data from the native computer program 506 about a list managed by the native computer program 506 (e.g., list 502), and thereby to create a reference to such a list;
provide data to the native computer program 506 about a list of data elements created by the embodiment (e.g., list 532);
provide data to the native computer program 506 about a new ordering of a list of data elements, where the new ordering is produced by the distinct list management module 522, and where the list of data elements may previously have been created and/or ordered either by the native computer program 506 or by the distinct list management module 522.

In the example of FIG. 5C, the list 532 is created and managed by the distinct list management module 522, in which case the list 532 is distinct from the native list 502. Alternatively, for example, the list management module 508′ of FIG. 5B may create and manage the list 532, thereby providing a mechanism that enables the native list 502 to remain unchanged by operations performed by the list management module 508′. Therefore, references herein to operations performed by the distinct list management module 522 of FIG. 5C on the list 532 should be understood to be applicable also to operations performed by the list management module 508′ of FIG. 5B on the list 532.

Although in the example of FIG. 5C the list 532 managed by the distinct list management module 522 solely contains data elements 534a-n created by the single native computer program 506, this is merely an example and does not constitute a limitation of the present invention. The list 532 may, for example, include at least one data element from the native computer program 506, and at least one data element from each of one or more additional native computer programs (not shown). For example, the list 532 may include at least one data element from each of two or more of the following: a messaging (e.g., email or text messaging) native computer program, a calendar native computer program, a task management native computer program, and a notification native computer program. As another example, the list 532 may include at least one data element from each of three or more of the following: a messaging (e.g., email or text messaging) native computer program, a calendar native computer program, a task management native computer program, and a notification native computer program.

Although only one list 532 managed by the distinct list management module 522 is shown in FIG. 5C, this is merely an example and not a limitation of the present invention. The distinct list management module 522 may create and otherwise manage (e.g., reorder) any number of lists. For example, the distinct list management module 522 may manage a plurality of lists that includes one or more of the following:
a first list containing data elements created by a first native computer program and a second list containing data elements created by the first native computer program;
a first list containing data elements created by a first native computer program and a second list containing data elements created by a second native computer program; and
a first list containing data elements created by a first native computer program, a second list containing data elements created by a second native computer program, and a third list containing data elements created by a third native computer program.

The same data element may be included in more than one list managed by the distinct list management module 522. For example, the distinct list management module 522 may manage two lists, each of which contains the same set of data elements, but where the two lists have different elements and/or different orders.

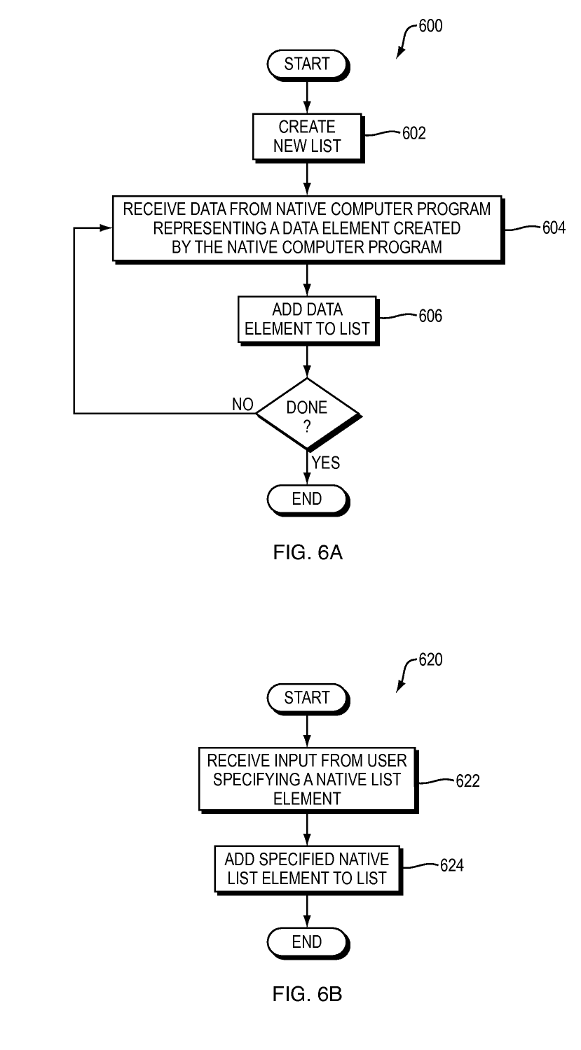

Referring to FIG. 6A, a flowchart is shown of a method 600 that is performed by the distinct list management module 522 in one embodiment of the present invention to produce the list 532 based on data obtained from the native computer program 506. Those having ordinary skill in the art will appreciate how to apply the techniques of FIG. 6A to produce the list 532 based on data obtained from a plurality of native computer programs, and to produce a plurality of lists, each of which may be produced based on data obtained from a single native computer program or a plurality of computer programs.

The method 600 creates a new list (FIG. 6A, operation 602). For example, the distinct list management module 522 may create the list 532 as an empty list. The method 600 receives data from the native computer program 506 representing a data element created by the native computer program 506, such as one of the data elements 504a-n in the list 502 (FIG. 6A, operation 604). The method 600 adds the received data element to the list 532 (FIG. 6A, operation 606). The method 600 determines whether any data elements remain to be received from the native computer program 506 (FIG. 6A, operation 608). If additional data elements remain to be received from the native computer program 506, the method 600 returns to operation 604 and repeats operation 604 for the next data element to be received from the native computer program 506. The method 600 then repeats operations 606 and 608, and more generally repeats operations 604-608 until there are no more data elements to be received. The method 600 then terminates. Once the list 532 has been created, any of the techniques disclosed herein may be applied to the list 532, such as reordering the list using the method 200 of FIG. 2.

The method 600 may, for example, be used to recreate all or a portion of the native list 502 in the list 532. For example, the method 600 may be used to recreate all or a portion of an email inbox or folder of a particular user, all or part of a calendar of a particular user, all or part of a task list of a particular user, or all of part of a notifications list of a particular user. The method 600 may, for example, apply a filter to the native list 502 to incorporate into the list 532 only those data elements in the native list 502 that satisfy the filter.

FIG. 6A illustrates a method 600 for automatically incorporating list elements from the native list 502 into the separate list 532. Alternatively or additionally, list elements may be incorporated into the separate list 532 from the native list 502 in other ways. For example, referring to FIG. 6B, a flowchart is shown of a method 620 for adding a native list element to the list 532 in response to user input specifying the native list element. For example, the method 600 may add a particular native list element to the list 532 in response to input from the user 204 specifying that the particular native list element should be ordered manually. In particular, the method 620 receives input from the user 204 specifying one of the elements 504a-n in the native list 502 (FIG. 6B, operation 622). Based on and in response to the user input, the method 600 adds the specified native list element to the list 532 (FIG. 6B, operation 624). The result of performing method 620 multiple times, for a plurality of native list elements, may be to populate list 532 solely with native list elements that were specified by the user to be ordered manually.

The user input may specify such a list element in any of a variety of ways. For example, the user 204 may select the specified native list element and issue a command to add the native list element to the list 532 (such as by clicking on an “add to activity list” button, or by dragging a manifestation of the native list element onto a manifestation of the list 532), in response to which the specified native list element may be added to the list 532 at some index, such as the top or bottom of the list 532. As another example, the user 204 may provide list element order input 206 (FIG. 2) in connection with the native list element, e.g., input specifying a desired index of the native list element, in response to which the specified native list element may be added to the list 532 at the user-specified index, or at an index based on the user-specified index.

The user input received in operation 622 may be received by, for example, the modified list management module 508′ or the distinct list management module 522. The native list element may be added to the list 532 by, for example, the modified list management module 508′ or the distinct list management module 522. For example, operations 622 and 624 may be performed in any of the following ways:
if the user input is received in operation 622 by the modified list management module 508′, then the modified list management module 508′ may add the user-specified native list element to the list 532 in operation 624;
if the user input is received in operation 622 by the modified list management module 508′, then the distinct list management module 522 may receive data from the modified list management module 508′ representing the user input, in response to which the distinct list management module 522 may add the user-specified native list element to the list 532 in operation 624; and
if the user input is received in operation 622 by the distinct list management module 522, then the distinct list ordering module 522 may add the user-specified native list element to the list 532 in operation 624.

In certain embodiments of the systems 520 and 530 of FIGS. 5B and 5C, respectively, the native list 502 may remain unchanged even after the performance of the method 200 of FIG. 2 and/or the method 600 (FIG. 6A) and 620 (FIG. 6B). For example, the list 532 may include list sequence data associated with some or all of the list elements in the native list 502, such as references to such list elements, where the list sequence data represents the user-specified order of the corresponding list elements in the native list 502. Such list sequence data may be stored in addition to and/or separately from the native list 502. In general, such list sequence data may be implemented in any of the ways disclosed herein.

An example of such list sequence data is shown in FIG. 5D, which illustrates an embodiment in which the list 532 maintained by the distinct list management module 522 contains list sequence data associated with some or all of the elements of the list 532. More specifically, in the embodiment of FIG. 5D, each of the list elements 534a-n contains a reference to and an index of a corresponding element in the native list 502. Note that in this example, the list 532 may not include data from the native list 502, such as the content of email messages, calendar appointments, tasks, or notifications. More specifically, list element 534a contains a reference 536a to a first element in the native list 502 and a sequence ID 538a of the first element; list element 534b contains a reference 536b to a second element in the native list 502 and a sequence ID 538b of the second element; list element 534c contains a reference 536c to a third element in the native list 502 and a sequence ID 538b of the third element; and list element 534n contains a reference 536n to an nth element in the native list 502 and a sequence ID 538n of the nth element. In such an embodiment the operations 606 (FIG. 6A) and 624 (FIG. 6B) of “adding” a data element from the native list 502 to the list 532 may include adding, to the list 532, a reference to the data element in the native list 502 and an index of the data element. The list 532 may be stored in addition to and/or separately from the list 502, such as on a different computer, virtual machine, computer-readable medium, or network node than the list 502.

The indices 538a-n in the list 532 of FIG. 5D are an example of “list sequence data” as that term is used herein. As illustrated by FIG. 5D, embodiments of the present invention may add list sequence data to, or otherwise associate list sequence data with, an existing list, such as the native list 502. In the case of FIG. 5C, the modified list management module 508′ may add list sequence data to, or otherwise associate list sequence data with, the native list 502. More generally, embodiments of the present invention may add any of a variety of data to, or otherwise associate any of a variety of data with, an existing list, such as the native list 502. Further examples of such techniques will be disclosed below.

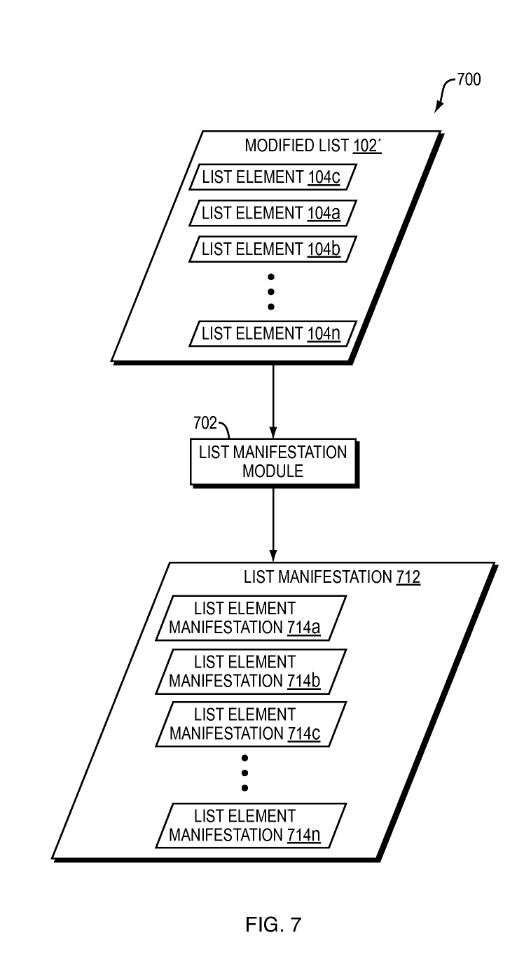

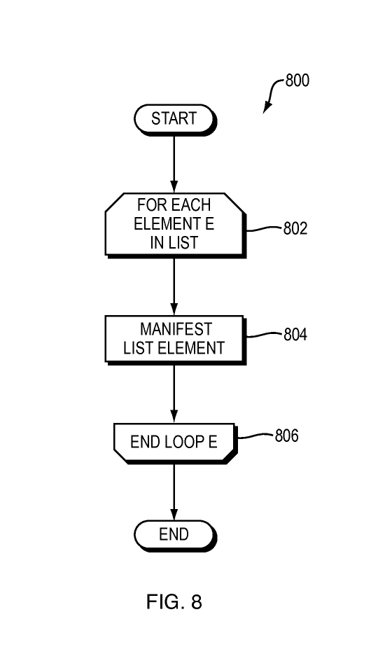

A list that is ordered by an embodiment of the present invention may be manifested in any of a variety of ways. For example, referring to FIG. 7, a dataflow diagram is shown of a system 700 for manifesting the ordered list 102′ according to one embodiment of the present invention. Referring to FIG. 8, a flowchart is shown of a method 800 performed by the system 700 of FIG. 7 according to one embodiment of the present invention. The system 700 includes a list manifestation module 702, which may be integrated with a native computer program in the manner disclosed above with respect to FIG. 5B, or be implemented distinctly from a native computer program in the manner disclosed above with respect to FIG. 5C. For example, the list manifestation module 702 may be integrated with any one or more of the native computer program 506 (e.g., the list management module 508 of the native computer program 506), the modified list management module 508′, and the distinct list management module 522.

The list manifestation module 702 enters a loop over each list element E in the ordered list 102′, in the order of the list elements 104a-n in the ordered list 102′, as specified by list sequence data associated with the ordered list 102′ (FIG. 8, operation 802). The list manifestation module 702 manifests list element E, thereby producing a manifestation of list element E, such as manifestation 714a (FIG. 8, operation 804). The list manifestation module 702 repeats operation 804 for the remaining list elements in the list 102′, in the order of those elements in the list 102′ (FIG. 8, operation 806). The result of the method 800 of FIG. 8 is a list manifestation 712, which contains manifestations 714a-n of the elements 104a-n in the list 102′, where the order of the manifestations 714a-n in the manifestation 712 corresponds to (e.g., is the same as) the order of the list elements 104a-n in the list 102.

The order of the list element manifestations 714a-n may correspond to the order of the corresponding list elements 104a-n in any of a variety of ways. For example, the list manifestation module 702 may spatially manifest the list element manifestations 714a-n in a manner that corresponds to the order of the corresponding list elements 104a-n, such as by spatially arranging the list element manifestations 714a-n sequentially from top to bottom, from bottom to top, from left to right, or from right to left. As another example, the list manifestation module 702 may temporally manifest the list element manifestations 714a-n in a manner that corresponds to the order of the corresponding list elements 104a-n. For example, the list manifestation module 702 may manifest the first list element in the list 102′ (e.g., list element 104a) during a first time period, manifest the second list element in the list 102′ (e.g., list element 104b) during a second time period having a start time that is later in time (or at least no earlier in time) than the start time of the first time period, manifest the third list element in the list 102′ (e.g., list element 104c) during a third time period having a start time that is later in time (or at least no earlier in time) than the start time of the second time period, and manifest the nth list element in the list 102′ (e.g., list element 104n) during an nth time period having a start time that is later in time (or at least no earlier in time) than the start time of the (n−1)th time period.

As a particular example of the above, the list manifestation module 702 may manifest each of the list elements 104a-n in a temporal sequence, such that at most one (e.g., exactly one) of the list elements' manifestations 714a-n is manifested (e.g., displayed) at any particular time. In such a case, no two of the manifestations 714a-n are manifested (e.g., displayed) contemporaneously. Upon satisfaction of some predetermined criterion (such as receiving some predetermined input from the user 204, such as pressing a “Complete,” “OK,” “Next,” or “Delete” button, or the lapse of a timer or occurrence of a predetermined time), the list manifestation module 702 may terminate the currently-manifested manifestation (e.g., by erasing or otherwise removing its display) and manifest the next list element in the list 102′. Such a technique may be used, for example, to enable each element in the list 102′ to be manifested one at a time, in the order of the list 102′, and to enable the user 204 to control the timing of the manifestation of the next element in the list 102′. Similar techniques may be used to enable the user 204 to navigate backwards through the list 102′. Similar techniques may be used to enable the list manifestation module 702 to display fewer than all but greater than one of the list elements 104a-n at a time, and to enable the user 204 to navigate through such subsets of the list 102′ in either direction.

The list manifestation 712, and the individual list element manifestations 714a-n may take any of a variety of forms. For example, the list manifestation 712 may be displayed as a list, table, or other visual element which indicates the order of the list 102′. Each of the list element manifestations 714a-n may, for example, contain manifestations of any of the data in the list elements 104a-n, including list sequence data.

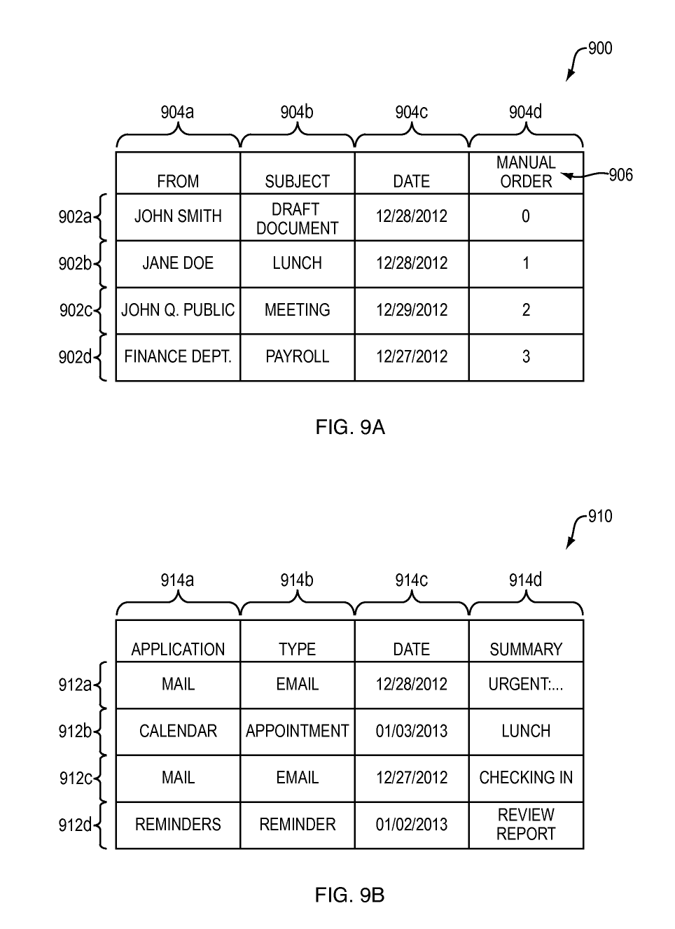

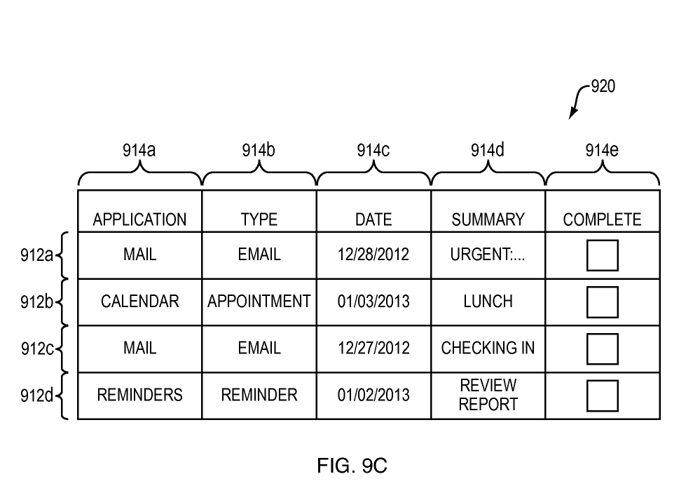

For example, referring to FIG. 9A, an illustration is shown of a user interface 900 representing the list manifestation 712 according to one embodiment of the present invention. The particular format and contents of the user interface 900 are shown merely for purposes of example and does not constitute a limitation of the present invention. For purposes of example and ease of illustration, assume that in connection with FIG. 9A the list elements 104a-n in the modified list 102′ consist of four email messages (i.e., n=4). The user interface 900 of FIG. 9A takes the form of a table containing a plurality of rows 902a-d representing the plurality of email messages 104a-n, respectively. The table 900 includes columns 904a-c representing the conventional email fields of “from” 904a, “subject” 904b, and “date” 904c. The table 900 also includes column 904d, representing list sequence data (e.g., sequence IDS) associated with the email messages 104a-n.

In the particular example of FIG. 9A, the user 204 may provide input indicating which of the columns 904a-d to use as a primary sort field for the data displayed in the table 900. For example, the user 204 may select (e.g., click on or tap) a heading of one of the columns 904a-d to indicate that the field represented by the selected column heading should be used as the primary sort field. The user 204 may toggle between an ascending sort direction and a descending sort direction by selecting the same column heading again. In response to such user input selecting a primary sort field and sort direction, the list ordering module 202 (FIG. 2), list management module 508′ (FIG. 5B), or distinct list management module 522 (FIG. 5C) may sort the modified list 102′ based on the primary sort field selected by the user 204, in the sort direction specified by the user 204. The list ordering module 202, list management module 508′, or distinct list management module 522 may then display the modified list 102′ in its new (sorted) order. In the example of FIG. 9A, the user 204 has selected the “manual order” column 904d as the primary sort field, and has selected “ascending” as the sort direction (as indicated by the upward-facing triangle 906). As a result, the table 900 is manifested in increasing order of the values in the “manual order” column.

Although the example illustrated in FIG. 9A uses only a single sort field, this is merely one example and does not constitute a limitation of the present invention. The modified list 102′ may be sorted by, and manifested in the order of, multiple sort fields in any order of priority, where one of the sort fields may be the manual sort field.

The particular columns 904a-d shown in FIG. 9A are merely examples and do not constitute limitations of the present invention. Any field or combination of fields may be included in the list manifestation 712. Furthermore, the list manifestation 712 may be sorted in the order of the user's manual ordering, but without displaying the user-specified indices (e.g., without displaying column 904d). For example, the user 204 may indicate that the list 102′ is to be manifested in order of its manual ordering by checking a “sort manually” box or providing an equivalent instruction, in response to which the list manifestation module 702 may manifest the list element manifestations 714a-n in order of their user-specified indices but without manifesting those user-specified indices.

More generally, each of the list manifestations shown herein (such as those shown in FIGS. 9A and 9B) may be associated with a corresponding set of properties, such as: (1) a set of ordered sort keys; (2) a set of fields (i.e., columns); and (3) a filter. A particular set of such properties is referred to herein as a “view property set.” Any list may be associated with zero, one, or more sets of view properties. When a particular list is manifested in accordance with a particular one of the list's view property sets: (1) only list elements satisfying the view property set's filters are manifested to produce a subset of the list; (2) only fields of the subset that are within the view property set's set of fields are manifested; and (3) the subset of the list is sorted according to the view property set's set of ordered sort keys, and the resulting sorted, filtered list is manifested.

A list maintained by an embodiment of the present invention (such as the list 532) may be associated with a view property set that differs from a view property set associated with the list by the native computer program associated with some or all of the elements in the list. As a result, the native computer program may manifest the list according to a first view property set, while an embodiment of the present invention may manifest the list according to a second view property set that differs from the first view property set. These two manifestations may be manifested contemporaneously. As just one particular example, the native computer program 506 may manifest the list 502 in order of the time of receipt of email messages in the list 502, whereas the distinct list management module 522 may manifest the list 532 (which may contain some or all of the email messages in the native list 502) in an order manually specified by the user 204. Both such manifestations may, for example, be manifested (e.g., displayed) contemporaneously, e.g., in separate windows. Such an embodiment enables users to retain the benefits of conventional sort orders (e.g., temporal sort orders), while also obtaining the benefit of the manual sort orders of embodiments of the present invention.

The list manifestation 712 (e.g., the table 900) may be integrated into a manifestation generated by the native computer program 506. For example, if the native computer program 506 includes the ability to display email messages in a table having columns 904a-c (FIG. 9A), then the modified computer program 506′ may include the ability to display email messages in a table having columns 904a-d (FIG. 9A). More generally, any of the techniques disclosed herein for generating the list manifestation 712 may be integrated into the modified native computer program 506′.

Alternatively, for example, the list manifestation 712 may be produced by a computer program, such as the distinct list management module 522 of FIG. 5C, that is distinct from the native computer program 506. For example, the native computer program 506 may manifest the email messages 104a-n, sorted by a field other than user-specified (i.e., manual) index, in one display area (e.g., window, pane, or tab), while the distinct list management module 522 may manifest the email messages 104a-n (e.g., in the form of table 900), sorted by user-specified index, in another display area (e.g., window, pane, or tab). Both such manifestations may be manifested contemporaneously and, as a result, may be visible to the user 204 contemporaneously.

Some list elements in a particular list may have a corresponding user-specified index, while other list elements in the particular list may have no corresponding user-specified index (or, equivalently, have a null corresponding user-specified index). Embodiments of the present invention may sort list elements by user-specified index in such a case in any of a variety of ways. For example, when sorting a list containing elements with a corresponding user-specified index and elements without a corresponding user-specified index, embodiments of the present invention may:
sort those elements having a corresponding user-specified index in order of those user-specified indices, and place those elements not having a corresponding user-specified index at the top of the list;
sort those elements having a corresponding user-specified index in order of those user-specified indices, and place those elements not having a corresponding user-specified index at the bottom of the list;
sort those elements having a corresponding user-specified index in order of those user-specified indices, and either remove from the list those elements not having a corresponding user-specified index or mark those elements as hidden so that they are not manifested when the list is manifested.

Although the list manifestation 900 of FIG. 9A represents only data elements of a single data type, possibly associated with a single native computer program, these are merely examples and do not constitute a limitation of the present invention. The list manifestation 712 may, for example, include manifestations of list elements of multiple data types, and/or manifestations of list elements associated with multiple computer programs. An example of such a list manifestation is shown in table 910 of FIG. 9B. The particular format and contents of the table 910 is shown merely for purposes of example and does not constitute a limitation of the present invention.

The table 910 contains a plurality of rows 912a-d representing a plurality of data elements. In the example of FIG. 9B, the data elements represented by the rows 912a-d include data elements of a plurality of data types, associated with a plurality of computer programs. The table 910 includes columns 914a-d representing the following fields: source application 914a, data type 914b, date 914c, and summary 914d. In particular:
row 912a represents an email message (column 914b) associated with the Apple Mail application (field 914a), having a date of Dec. 28, 2012 (field 914c), and a summary of: “URGENT: Please reply immediately”;
row 912b represents a calendar appointment (column 914b) associated with the Apple Calendar application (field 914a), having a date of Jan. 3, 2013 (field 914c), and a summary of: “Lunch today”;
row 912c represents an email message (column 914b) associated with the Apple Mail application (field 914a), having a date of Dec. 27, 2012 (field 914c), and a summary of: “Checking in”; and
row 912d represents a reminder (column 914b) associated with the Apple Reminders application (field 914a), having a date of Jan. 2, 2013 (field 914c), and a summary of: “Review report”.

Although the table 910 does not include a “manual order” (i.e., user-specified index) column and does not include the user-specified indices of any of the list elements 104a-n, the list element manifestations 912a-d in FIG. 9B are sorted in increasing order of user-specified index. As illustrated by FIG. 9B, the result of manifesting the list 102′ in order of its user-specified indices may be to intersperse manifestations of data elements having differing data types with each other. For example, as can be seen from the values in the “type” column 914b in FIG. 9B, the data elements 104a-n are not grouped or sorted by data type in the table 910, but rather any data element of any type may appear at any position in the table 910. In particular, the manifestations of two data elements having the same data type may be separated by the manifestation of one or more data elements having another data type (as illustrated in FIG. 9B by the two email manifestations 912a and 912c being separated by the calendar appointment manifestation 912b).

Similarly, as illustrated by FIG. 9B, the result of manifesting the list 102′ in order of its user-specified indices may be to intersperse manifestations of data elements associated with different native computer programs with each other. For example, as can be seen from the values in the “application” column 914a in FIG. 9B, the data elements 104a-n are not grouped or sorted by application (i.e., computer program) in the table 910, but rather any data element associated with any computer program may appear at any position in the table 910. In particular, the manifestations of two data elements associated with the same computer program may be separated by the manifestation of one or more data elements associated with another computer program (as illustrated in FIG. 9B by the two Apple Mail manifestations 912a and 912c being separated by the Apple Calendar manifestation 912b).

In any of the embodiments of the list manifestation 712 disclosed herein, such as the table 900 of FIG. 9A and the table 910 of FIG. 9B, embodiments of the present invention may enable the user 204 to provide input in connection with the list manifestation 712 to manually reorder the underlying list 102′, such as by using any of the techniques disclosed above in connection with FIGS. 2, 3 and 4A-4C.

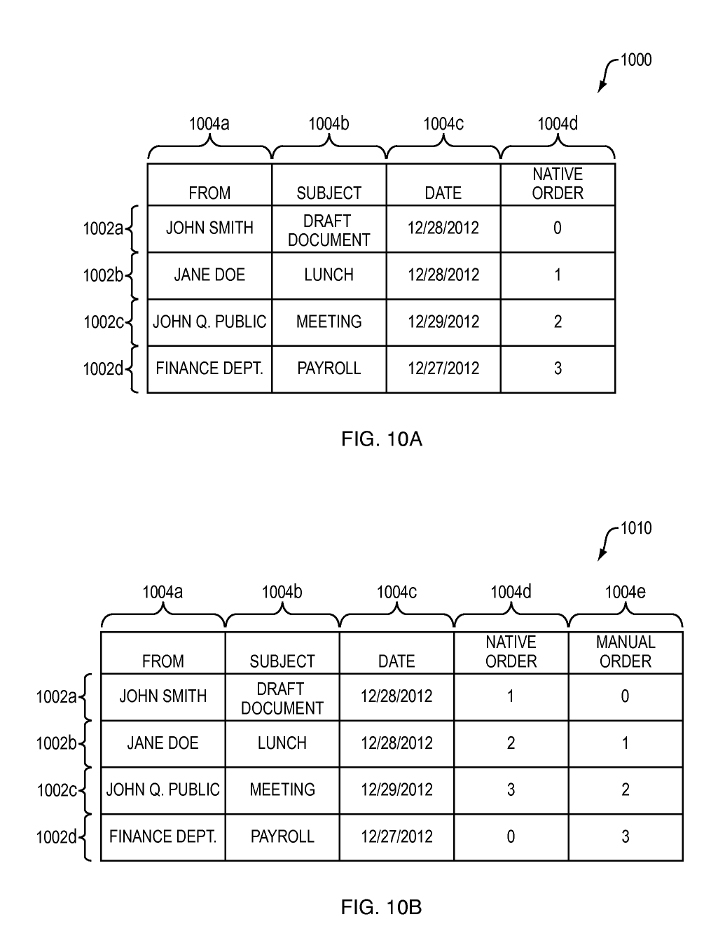

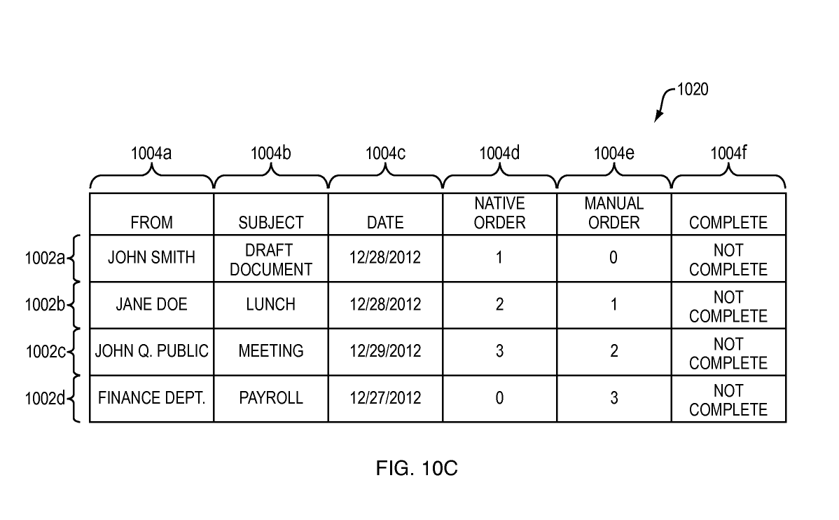

Embodiments of the present invention may replace or supplement existing list orders (e.g., sort orders provided by native computer programs) with user-specified (i.e., manual) list orders. For example, referring to FIG. 10A, an illustration is shown of a list 1000. The list 1000 may, for example, be an instance of the list 502 maintained by the native computer program 506. The particular format and contents of the list 1000 are shown merely for purposes of example and do not constitute a limitation of the present invention. For purposes of example and ease of illustration, assume that the list elements 1002a-d in FIG. 10A consist of four email messages (i.e., n=4). Each of the list elements 1002a-d has four fields: a “from” field 1004a, a “subject” field 1004b, a “date” field 1004c, and a “native order” field 1004d.

The native order field 1004d of the list elements 1002a-d contains list sequence data (e.g., sequence IDs) associated with the list elements 1002a-d. The native order field 1004d may alternatively be implemented in any of the ways described herein for list sequence data. For example, the contents of the native order field 1004d need not be stored as part of the list 1000, but may instead, for example, be stored separately, such as in data associated with a view (e.g., manifestation) of the list 1000. However, the native order field 1004d is shown as part of the list 1000 in FIG. 10A for ease of illustration.

The native computer program 506 may assign values to the native order field 1004d of the list elements 1002a-d in any of a variety of ways. For example, if the user 204 issues a command to the native computer program 506 to sort the list 1002d by the date field 1004c, then the native computer program 506 may sort the list 1002d by the date field 1004c and assign values to the native order field 1004d of the list elements 1002a-d to specify an order of the list elements 1002a-d which orders the list elements 1002a-d by date.

Embodiments of the present invention may add, to a native list such as the list 1000, list sequence data which specifies a user-specified (i.e., manual) order of the list 1000. For example, referring to FIG. 10B, a list 1010 is shown according to one embodiment of the present invention. For purposes of example, the list 1010 of FIG. 10B is identical to the list 1000 of FIG. 10A, except that the list 1010 of FIG. 10B has an additional “manual order” field 1004e. This manual order field 1004e contains values that were specified manually by the user 204. The manual order field 1004e therefore plays the same role of the manual order field 904d of the manifestation 900 in FIG. 9A.

The manual order field 1004e of the list elements 1002a-d contains list sequence data (e.g., sequence IDs) associated with the list elements 1002a-d. The manual order field 1004e may alternatively be implemented in any of the ways described herein for list sequence data. For example, the contents of the manual order field 1004e need not be stored as part of the list 1010, but may instead, for example, be stored separately, such as in data associated with a view (e.g., manifestation) of the list 1010. As a particular example, the list 1000 (i.e., columns 1004a-d in FIG. 10B) may be maintained by the native computer program 506, whereas the manual order field 1004e may be maintained by the distinct list management module 522, e.g., in the list 532. However, the manual order field 1004e is shown as part of the list 1010 in FIG. 10B for ease of illustration.

As FIGS. 10A and 10B illustrate, embodiments of the present invention may be used to provide the ability to manually order a list, such as the list 1000, even when the native computer program associated with that list does not provide such an ability, and without eliminating the ability to sort the list non-manually (i.e., automatically). For example, as shown in FIG. 10B, the manual order field 1004e may supplement, rather than replace, the native order field 1004d (and any other automatic sorting capabilities provided by the native computer program 506).

One implication of this feature of embodiments of the present invention is that such embodiments may enable the user 204 to switch between manifestations of a list in which the list is ordered automatically and manifestations of the list in which the list is ordered manually. For example, consider again the manifestation 900 of FIG. 9A. Assume for purposes of example that this manifestation 900 is a manifestation of the list 1010 of FIG. 10B. In manifestation 900, the list 1010 is ordered manually (i.e., according to manual order field 904d). The user 204 may provide input representing an instruction to order the list 1010 automatically, such as by clicking on the heading of the date field 904c, in response to which an appropriate component (such as component 508, 508′, or 522) may sort the list 1010 automatically by its date column 1004c, modify the contents of the native order column 1004d to reflect the new sorted order of the list 1010, and then re-manifest the list 1010 to produce a manifestation (not shown) which is similar to the manifestation 900 of FIG. 9A, but in which the list elements 902a-d are ordered by date.

Although such a manifestation does not order the list elements 902a-d by manual order, and may not even manifest the contents of the manual order column 1004e (e.g., the manifestation may omit column 904d of FIG. 9A), the underlying manual order data 1004e may be retained. As a result, if the user 204 subsequently provides input representing an instruction to order the list 1010 manually, such as by clicking on the heading of the manual order field 904d, an appropriate component (such as component 508′ or 522) may re-manifest the list 1010 to produce a manifestation (such as a manifestation that is identical to the manifestation 900 of FIG. 9A) in which the list elements 902a-d are ordered based on the manual sort order previously specified by the user 204. Such an embodiment thereby allows the user 204 to retain the benefits of automatic sorting without requiring the user 204 to re-specify the user's desired manual order each time the user 204 wishes to manifest the list 1010 in that desired manual order.

Similarly, the combination of automatic order data in the native order column 1004d of the list 1010 and the manual order data in the manual order column 1004e of the list 1010 may be used to produce multiple contemporaneous manifestations of the list 1010, including at least one manifestation which manifests the list elements 1002a-d in the order specified by the native order column 1004d and at least one manifestation which manifests the list elements 1002a-d in the order specified by the manual order column 1004e. Such an embodiment thereby allows the user 204 to obtain the benefits of automatic and manual ordering contemporaneously.

Although the list 1010 in FIG. 10B includes exactly one native order field 1004d and exactly one manual order field 1004e, this is merely an example and does not constitute a limitation of the present invention. For example, the lists 1000 and 1010 may include any number of native order fields (e.g., 1, 2, or more) representing orders that were produced automatically by the corresponding native computer program. Similarly, the list 1010 may include any number of manual order fields (e.g., 1, 2, or more) representing orders that were manually specified by the user 204.

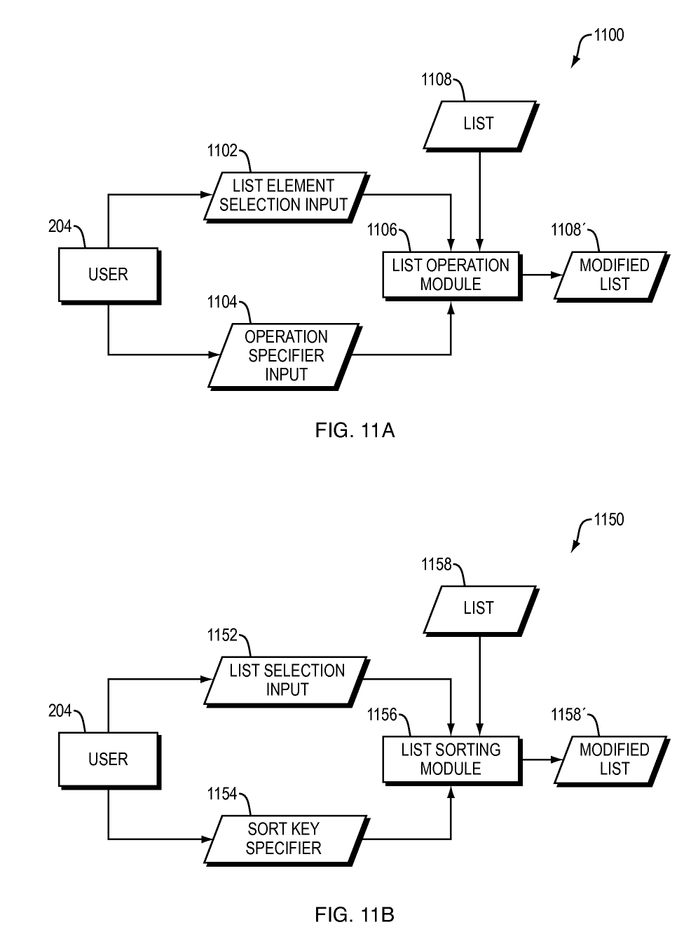

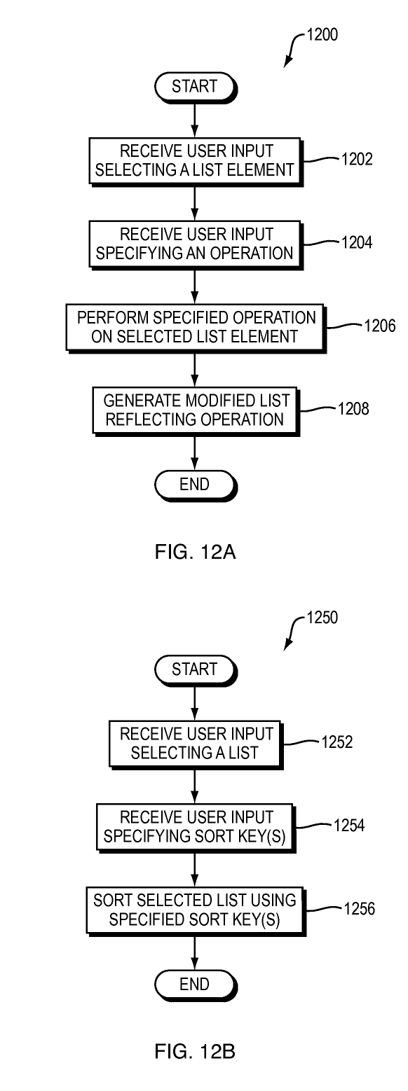

As described herein, embodiments of the present invention may generate manifestations of lists, such as the manifestations 900 (FIG. 9A) and 910 (FIG. 9B). Embodiments of the present invention may enable the user 204 to manipulate the underlying lists and list elements represented by those manifestations by providing input in connection with those elements. For example, referring to FIG. 11A, a dataflow diagram is shown of a system 1100 for performing operations on list elements according to one embodiment of the present invention. Referring to FIG. 12A, a flowchart is shown of a method 1200 performed by the system 1100 of FIG. 11A according to one embodiment of the present invention.

The system 1100 includes a list operation module 1106, which may, for example, be implemented in any of the ways described herein in connection with the modified list management module 508′ and the distinct list management module 522. The system 1100 also includes a list 1108, which may, for example, be any of the lists disclosed herein (e.g., list 102′, list 502, or list 532). The user 204 provides input 1102 specifying a particular list element in the list 1108 (FIG. 12A, operation 1202). For example, the user 204 may provide the input 1102 in connection with a manifestation of the list 1108, such as by clicking, tapping, or otherwise selecting a manifestation of the particular list element.

The user 204 also provides input 1104 specifying an operation to perform on the particular list element (FIG. 12A, operation 1204). Examples of such operations include opening (e.g., manifesting) the particular list element, deleting the particular list element, removing the particular list element from the list 1108, modifying the contents of the particular list element, and modifying the manual order of the particular list element within the list 1108. The inputs 1102 and 1104 may be implemented as a single input. For example, tapping on a manifestation of a particular list element may serve both to select that particular list element (input 1102) and to specify that an “open” operation should be performed on that particular list element (input 1104). As another example, dragging a manifestation of a particular list element to a new position within a manifestation of the list 1108 may serve both to select that particular list element (input 1102) and to specify that the operation to be performed on that particular list element is changing the manual order of that particular list element (input 1104).

In response to receiving inputs 1102 and 1104, the list operation module 1106 performs the specified operation on the particular list element (FIG. 12A, operation 1206). In the case of certain operations which change the particular list element (such as deleting or changing the manual order of the particular list element), the list operation module 1106 may also generate a modified list 1108′ which is identical to the list 1108 (FIG. 12A, operation 1208), except that the modified list 1108′ reflects the operation that was performed on the particular list element in operation 1206. For example, if the manual order of the particular list element was modified in operation 1206, then the modified list 1108′ may contain the same elements as the original list 1108, but ordered to reflect the new manual order of the particular list element. As another example, if the particular list element was removed from the list 1108 in operation 1206, then the modified list 1108′ is identical to the list 1108 except that the modified list 1108′ does not contain the particular list element.

Similarly, embodiments of the present invention may enable the user 204 to re-sort the list 1108 based on any sort key(s). Referring to FIG. 11B, a dataflow diagram is shown of a system 1150 for sorting the list 1108 according to one embodiment of the present invention. Referring to FIG. 12B, a flowchart is shown of a method 1250 performed by the system 1150 of FIG. 11B according to one embodiment of the present invention.

The user 204 provides input 1152 specifying a particular list, e.g., the list 1108 (FIG. 12B, operation 1252). For example, the user 204 may provide the input 1152 in connection with a manifestation of the list 1108, such as by clicking, tapping, or otherwise selecting a manifestation of the list 1108.

The user 204 also provides input 1154 specifying one or more sort keys (FIG. 12B, operation 1254). Examples of such sort keys include any of the columns shown in FIGS. 9A-9B and FIGS. 10A-10B. The inputs 1152 and 1154 may be implemented as a single input. For example, tapping on a manifestation of a column heading may serve both to select the list containing the column (input 1152) and to specify that column as a sort key (input 1154).

In response to receiving inputs 1152 and 1154, the list operation module 1156 sorts the specified list 1108 based on the specified sort key(s) (FIG. 12B, operation 1256), thereby generating a modified list 1158′ which is identical to the list 1108 (FIG. 12B, operation 1258), except that the modified list 1158′ reflects the sort order resulting from operation 1256.

The systems and methods of FIGS. 11A-11B and 12A-12B may receive data from and/or provide data to one or more native computer programs (e.g., the native computer program 506). For example, if the operation to be performed on the particular list element in FIGS. 11A and 12A is an “open” operation, and the list 1108 does not include by value all of the data in the list element that is required to open (e.g., manifest) the particular list element, then the list operation module 1106 may, as part of performing the “open” operation, receive data in the particular list element from the particular list element's native computer program, such as by requesting and receiving such data via an API or other suitable mechanism. The list operation module 1106 may or may not store the received data in the list 1108 or the modified list 1108′. The list operation module 1106 may, for example, obtain the received data for the purpose of manifesting such data but not store such data permanently (e.g., in the lists 1108 or 1108′).

As another example, if the operation to be performed on the particular list element in FIGS. 11A and 12A involves modifying and/or deleting some or all of the particular list element, then the list operation module 1106 may, as part of performing such an operation, provide commands and/or data to the particular list element's native computer program sufficient to enable that native computer program to perform some or all of the modify and/or delete operation on the particular list element maintained by the native computer program. For example, if the operation involves changing the value of data in the particular list element, then the list operation module 1106 may, as part of performing such an operation, provide commands and/or data to the particular list element's native computer program sufficient to enable that native computer program to change the value of the data in the particular list element maintained by the native computer program. If an embodiment of the present invention (e.g., the modified list management module 508′ or the distinct list management module 522) maintains its own partial or complete copy of the particular list element, then the list operation module 1106 may also perform some or all of the operation on that copy of the particular list element. As a result, the copy of the particular list element maintained by the native computer program may remain in sync with the copy of the particular list element maintained by the embodiment of the present invention. Similar techniques may be used by the list operation module 1106 to cause the native computer program 506 to update the order of a list maintained by the native computer program 506 in response to a change in the order of the list 1108 made by the list operation module 1106.

Although the description of the systems and methods of FIGS. 11A-11B and 12A-12B may refer to “the native computer program,” it should be appreciated that any of the techniques disclosed in connection with FIGS. 11A-11B and 12A-12B (and any of the techniques disclosed herein) may be applied to the list 1108 even if the list 1108 contains elements associated with a plurality of native computer programs. For example, the list operation module 1106 may perform a first operation on a first element of the list 1108, where the first element is associated with a first native computer program, and perform a second operation on a second element of the list 1108, where the second element is associated with a second native computer program that differs from the first native computer program. As a result, as the user 204 uses the list operation module 1106 to perform operations on various elements of the list 1108, the list operation module 1106 may propagate the results of such operations back to the respective native computer program(s) of such elements of the list 1108.

Although the systems and methods of FIGS. 11A-11B and 12A-12B operate in response to input provided by the user 204 to the list operation module, this is merely an example and does not constitute a limitation of the present invention. Those with ordinary skill in the art will appreciate how to apply the techniques of FIGS. 11A-11B and 12A-12B to enable the results of operations performed on a list by a native computer program (e.g., the native computer program 506) to be propagated to the list operation module 1106 and thereby to enable the results of those operations to be reflected in the list 1108. For example, if the user 204 uses the native computer program 506 to delete a data element (e.g., to delete an email message), embodiments of the present invention may provide commands and/or data to the list operation module 1106 sufficient to enable the list operation module 1106 to delete the element from the list 1108. Similarly, if the user 204 uses the native computer program 506 to add a data element (e.g., to add a task), embodiments of the present invention may provide commands and/or data to the list operation module 1106 sufficient to enable the list operation module 1106 to add the element to the list 1108.

Although the systems and methods of FIGS. 11A-11B and 12A-12B operate in response to input from the user 204, this is merely an example and does not constitute a limitation of the present invention. Those with ordinary skill in the art will appreciate how to apply the techniques of FIGS. 11A-11B and 12A-12B to propagate the results of operations automatically (i.e., not in response to user input) from the list operation module 106 to a native computer program and/or from the native computer program to the list operation module 106 and thereby to enable the results of those operations to be reflected in the list 1108 and in lists maintained by the native computer program. Such automatic propagation may be performed, for example, by: (1) pulling data, e.g., periodically; and/or (2) pushing data, e.g., periodically or in response to a change in data (in response to re-ordering a list, adding an element to a list, deleting an element from a list, or modifying the contents of a list element). For example, if a native email program receives a new email message and adds the message to a native email inbox, the new email message may be pushed automatically to the list operation module 1106, which may store the new email message in the list 1108, thereby creating the modified list 1108′.

As the example just described indicates, new list elements may be added to lists maintained by embodiments of the present invention. For example, the user 204 may manually add a new list element to a list maintained by an embodiment of the present invention. As another example, a native computer program may cause a new list element to be added to a list maintained by an embodiment of the present invention. In such cases, the newly-added list element may lack any user-specified (i.e., manual) order with respect to the list. Some or all of the other elements in the list may, however, have one or more user-specified orders with respect to the list. In other words, existing elements in the list may be associated with list sequence data associated with the list, whereas the newly-added list element may not be associated with any list sequence data associated with the list.

Embodiments of the present invention may handle such a situation in any of a variety of ways. For example, embodiments of the invention may not take any special action to assign a manual order to such new list elements. As a result, such new list elements may be treated in the manner disclosed elsewhere herein. The user 204 may subsequently assign one or more manual sort orders to such new list elements in any of the ways disclosed herein.

As another example, embodiments of the present invention may automatically assign a manual order to an element in response to the element being added to a list. Such automatic assignment may be performed in any of a variety of ways. For example, embodiments of the present invention may assign a lowest manual order in the list to the new element (i.e., a manual order that is less than the manual order of all other elements in the list), or assign a highest manual order in the list to the new element (i.e., a manual order that is greater than the manual order of all other elements in the list). As another example, when a new element is added to a list, embodiments of the present invention may prompt the user to specify a manual order for the element in the list, in response to which the user may specify such an order in any of the ways disclosed herein, in response to which embodiments of the present invention may assign the user-specified order to the element in the list. The user may or may not be required to specify such a manual order for the element in the list. Any of these techniques for automatically assigning a manual order to an element newly added to a list may be performed, for example, only if the list currently is sorted (e.g., manifested) in manual order.

Embodiments of the present invention may be used to enable the user 204 to mark any element in a list as “complete.” For example, embodiments of the present invention may be used to enable the user 204 to mark a message (e.g., an email message or text message), an appointment, or a task as complete. This feature may be combined with the ability to enable the user 204 to manual order a list. For example, embodiments of the present invention may enable the user 204 to manually order a list of any of the kinds disclosed herein in any of the manners disclosed herein, and then to mark one or more elements in the manually-ordered list as complete. Embodiments of the present invention take an appropriate action in response to a list element being marked as complete, such as removing the element from the list. In this way, embodiments of the present invention may be used to transform messages, calendar appointments, and other non-actionable data elements into actionable data elements that may be used productively as tasks and, if desired, integrated into a single list with tasks maintained by native task management programs.

For example, referring to FIG. 10C, a list 1020 is shown according to one embodiment of the present invention. For purposes of example, the list 1020 of FIG. 10C is identical to the list 1010 of FIG. 10B, except that the list 1020 of FIG. 10C has an additional “complete” field 1004f. Each element in the list 1020, therefore, has a corresponding complete field with its own value. The complete field 1004f may, for example, have a binary data type, which has two permissible values, which may be thought of as “complete” and “not complete.” This is merely an example, however, and not a limitation of the present invention. The complete field 1004f may have other data types, such as an integer data type capable of containing value indicating a percentage of completion ranging from 0-100. The complete field 1004f of each of the list elements 1002a-d may initially be assigned a default value, such as “not complete.”

The particular list elements 1002a-d in FIG. 10C are all email messages. This is merely an example and does not constitute a limitation of the present invention. Any of the techniques disclosed herein in connection with FIG. 10C, and in connection with the complete field 1004f and the feature of enabling list elements to be marked as complete more generally, may be applied more generally to lists containing any type(s) of data elements. For example, such techniques may be applied in connection with a list such as that illustrated in FIG. 9B, which contains email messages, appointments, and tasks.

Assume for purposes of example that the native email program that created the email messages represented in the list 1020 of FIG. 10C does not associate a complete field with such email messages. When a component of the present invention (such as the modified list management module 508′ or the distinct list management module 522) adds such an email message to the list 1020, such a component may associate the complete field 1004f with the email message.

Certain native data elements, however, such as native tasks, may already be associated with a complete field or similar field by their associated native computer program. When a component of the present invention adds such a data element to the list 1020, such a component may or may not associate the complete field 1004f with such a data element. For example, the component may associate the complete field 1004f with the data element, as a result of which the data element will be associated with two complete fields (i.e., the native complete field and the complete field 104f). Alternatively, for example, the component may not associate the complete field 1004f with the data element, as a result of which embodiments of the present invention may use the data element's existing complete field to perform the functions disclosed herein in connection with the complete field 1004f. As these examples imply, a single list generated by an embodiment of the present invention may include both: (1) elements associated with the complete field 1004f; and (2) elements not associated with the complete field 1004f, but associated with a complete field from their associated native computer program.

When adding a new element to a list, a component (such as the modified list management module 508′ or the distinct list management module 522) may determine whether the element already is associated with a complete field (whether or not the name of such a field is “complete”), by which is meant a field that indicates whether an activity associated with the element is complete. If the component determines that the element already is associated with a complete field, then the component may not associate the element with the complete field 1004f. If the component does not determine that the element already is associated with the complete field, then the component may associate the element with the complete field 1004f.

A list element and associated complete field 1004f (or other mechanism for marking the list element as complete) is referred to herein as an “activity data element,” which represents what is referred to herein as an “activity.” For example, in FIG. 10C, email message 1002a, including its associated complete field 1004f, is an activity data element representing an activity. Similarly, an appointment or task with an associated mechanism for marking the appointment or task as complete is an activity data element representing an activity. An activity data element is actionable because it is capable of being marked as complete by a user. Because embodiments of the present invention may add to a data element a mechanism for marking the data element as complete (such as an email message), where the data element did not otherwise include such a mechanism, embodiments of the present invention may be used to turn non-actionable data elements into actionable data elements.

Furthermore, embodiments of the present invention may be used to enable a user to manually order activity data elements representing activities. Embodiments of the present invention, in other words, may be used to enable users to manually prioritize activities.

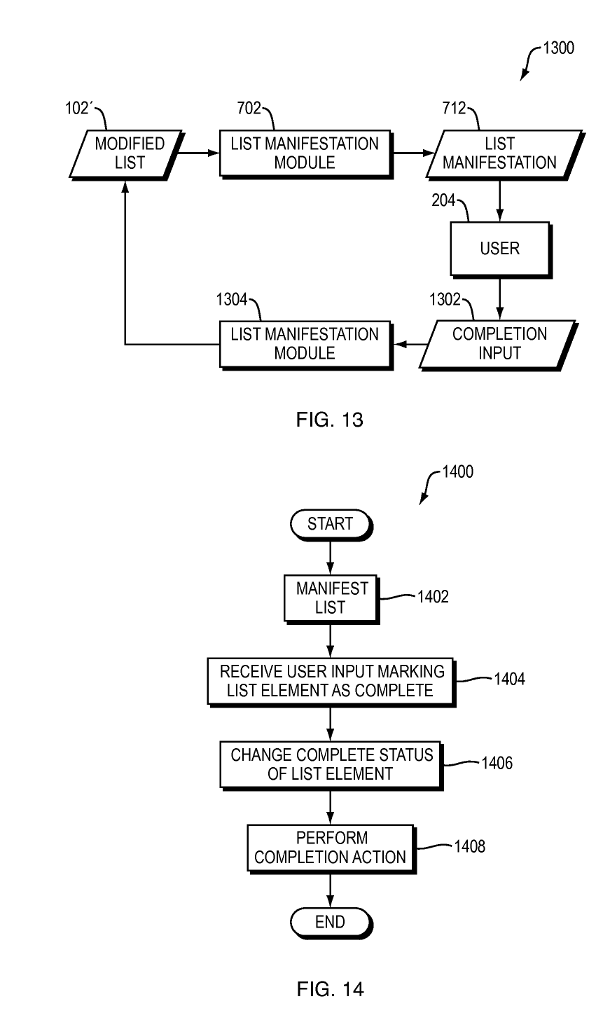

Embodiments of the present invention may use any of a variety of techniques to enable a user to process activity data elements. One example of a system 1300 for enabling a user to process activity data elements is shown in FIG. 13. Referring to FIG. 14, a flowchart is shown of a method 1400 performed by the system 1300 in one embodiment of the present invention.

The system 1300 may include the elements of the system 700 of FIG. 7, such as the modified list 102′, the list manifestation module 702, and the list manifestation 712. The modified list 102′ may, for example, include the features of the list 1020 of FIG. 10C, such as the manual order field 1004e and the complete field 1004f. The list manifestation module 702 may manifest the list 102′ using, for example, the techniques of FIGS. 7 and 8, to produce the list manifestation 712 (FIG. 14, operation 1402).

An example list manifestation 920 that may be produced by FIGS. 13 and 14 is shown in FIG. 9C. As illustrated therein, the list manifestation 920 may be similar to the manifestation 910 of FIG. 9B, but additionally include a “complete” column 914e, which manifests and thereby represents the contents of the complete field 1004f of the manifested list. In the particular example of FIG. 9C, a checkbox appears in the complete column 914e of each of the rows 912a-d, where an unchecked checkbox represents a complete value of “not complete,” and where a checked checkbox represents a complete value of “complete.” The particular form of the complete column 914e in FIG. 9C is merely an example and does not constitute a limitation of the present invention. The values in the complete field 1004f may be manifested in other ways, not all of which include discrete manifestations of all of the values in the complete field 1004f (such as the checkboxes in FIG. 9C). For example, list elements having a complete value of “complete” may be omitted from the manifestation 930 to indicate that those elements require no further action. In other words, the contents of the complete field 1004f of the items in the list 102′ may be manifested by manifesting only non-complete list elements.

The system 1300 also includes a list completion module 1304, which may be implemented in any of the ways disclosed herein for other components of embodiments of the present invention (such as the modified list management module 508′ and the distinct list management module 522). The user 204 provides input 1302 specifying that a particular one of the elements in the list 102′ should be marked as complete (e.g., that the value of the list element's complete field 1004f should be changed from “not complete” to “complete”).

The completion input 1302 may take any of a variety of forms. For example, in FIG. 9C, the user input 1302 may take the form of checking a box in the complete column 914e. Other examples of completion input 1302 include input representing an instruction to open, close, delete, forward, reply to, attach a label or tag to, or move to a container (e.g., folder) a particular list element. Such input 1302 may be provided to the list completion module 1304 directly by the user 204, or the user may provide such input 1302 to the native computer program 506, in response to which the list completion module 1304 may receive an indication that the user 204 has provided such input 1302 to the native computer program 506. For example, the user 204 may move an email message from the email inbox of the native computer program 506 to a folder maintained by the native computer program. The list completion module 1304 may receive an indication of such a move, which the list completion module 1304 may interpret as a specification by the user 204 that the email message should be marked as complete.

In response to receiving the user input 1302, the list completion module 1304 marks the specified list element as complete (FIG. 14, operation 1404). Recall that a list element may have more than one complete field (if, e.g., the list element has both a native complete field and a complete field that was added by an embodiment of the present invention). If a list element has more than one complete field, then operation 1404 may, for example, involve either of the following in the list element: (1) marking only the complete field 1004f that was added by an embodiment of the present invention as complete; or (2) marking both the complete field 1004f that was added by an embodiment of the present invention as complete and marking the native complete field as complete.

The list completion module 1304 may also perform a completion action in connection with the particular list element that was marked as complete in operation 1404 (FIG. 14, operation 1406). Examples of completion actions include removing the list element from the list 102′, deleting the list element, removing the manual order field from the list element (or otherwise setting the value of the manual order field to a null value), associating a tag or label with the list element, and moving the list element to a container (e.g., a folder, such as a deleted items folder or a completed items folder). The list completion module 1304 may perform zero, one, or more such completion actions in operation 1406.

Certain systems, such as the Google Gmail email system, associate an “archived” field with each list element. In the example of Gmail, email messages in which the value of the archived field is “not archived” are displayed in the user's inbox, whereas email messages in which the value of the archived field is “archived” are not displayed in the user's inbox. Embodiments of the present invention may, for example, provide the complete field 1004f in addition to the archived field provided natively by a system such as Gmail. As a result, a Gmail email message may be archived and complete, archived and not complete, not archived but complete, or not archived and not complete. As just one example of how such combinations may be experienced by the user 204 in embodiments of the present invention, email messages that are archived and complete may not appear in the user's inbox or in manifestations of lists produced by embodiments of the present invention; email messages that are archived and not complete may not appear in the user's inbox but appear in manifestations of lists produced by embodiments of the present invention; email messages that are not archived but complete may appear in the user's inbox but not appear in manifestations of lists produced by embodiments of the present invention; and email messages that are not archived and not complete may appear in the user's inbox and in manifestations of lists produced by embodiments of the present invention.

Operation 1406 may include both selecting a completion action to perform from among a plurality of completion actions, and performing the selected completion action. The list completion module 1304 may select the completion action to perform in connection with a particular list element in any of a variety of ways. For example:
a predetermined completion action may be associated with the list 102′, such as a completion action previously specified by the user 204 in association with the list 102′, in which case the list completion module 1304 may select the completion action for the list element as the completion action associated with the list that contains the list element;
a predetermined completion action may be associated with the activity type (e.g., email message, appointment, or task) of the list element, such as a completion action previously specified by the user 204 in association with the list element's activity type, in which case the list completion module 1304 may select the completion action for the list element as the completion action associated with the list element's activity type; or
the list completion module 1304 may prompt the user 204 to select a completion action to perform in connection with the list element in response to receiving the completion input from the user 1302, in response to which the user 204 may provide further input selecting a particular completion action, in response to which the list completion module 1304 may perform the selected completion action in connection with the list element.

As the examples above illustrate, different completion actions may be associated with different lists, activity types, and/or list elements.

Although not shown in FIGS. 13 and 14, the list manifestation module 702 may re-manifest the list 102′ after the step 1404 and/or 1406 to reflect the change in the selected list element's completion status and/or the results of performing the completion action. As one particular example, once the selected list element has been marked as complete 920, if the list 102′ if re-manifested by the list manifestation module 702, the new manifestation may represent the completion status of the selected list element, such as by displaying the checkbox (in column 914e) of that list element as checked, or by not including a manifestation of the list element at all. As the latter example illustrates, marking the selected list element as complete may cause the selected list element to effectively be removed from the manifestation of the list 102′. As another example, if the list manifestation module 702 is configured to manifest only one list element at a time, then in response to one list element being marked as complete, the list manifestation module 702 may remove the manifestation of that list element, and manifest the next list element in the list 102′ according to the list's manual sort order.

One benefit of allowing the user 204 to both manually order the list 102′ and to pre-specify completion actions is that the user may separate out the processes of: (1) selecting an order in which to process activities; (2) selecting the completion action to perform in connection with activities; and (3) processing the activities themselves. For example, the user 204 may:
manually order the entire list 102′ before processing (e.g., replying to or reading in full) any of the elements in the list 102′;
assign a completion action to the entire list 102′ before processing any of the elements in the list 102′; and then
process some or all of the elements in the list 102′ in their manually-specified order and mark each such element as complete after processing it, thereby causing the list completion module to perform the predetermined completion action in connection with each list element after that list element has been marked as complete.

Such a process is likely to be less cognitively demanding on the user 204, and therefore is likely to be more efficient, than the conventional method of processing activities, in which the user 204: (1) selects a list element to process (possibly by reviewing some or all of the list elements for importance); (2) processes (e.g., reads and/or responds to) the selected list element; (3) selects a completion action to perform on the list element; (4) performs the completion action on the list element manually (such as by manually moving the list element to a folder or manually deleting the list element); and (5) returns to step (1) for another element in the list. Such a process is suboptimal for a variety of reasons. For example, it requires the user 204 to switch repeatedly among several different types of actions (e.g., prioritizing, processing, completing) for each list element, rather than performing actions of the same type together for multiple list elements (such as selecting the priority of all list elements without interruption). As another example, it causes the user 204 to review the same list elements multiple times, such as when the user 204 scans some or all of the list 102′ each time the user 204 tries to find the list element with the highest priority in the list. In contrast, embodiments of the present invention may be used to reduce the cognitive switching costs imposed on the user 204 by enabling the user 204, for example, to prioritize the list 102′ once and then process the list 102′ in its prioritized (i.e., manually sorted) order, thereby eliminating or reducing the need for the user 204 to prioritize the list 102′ again, and thereby enabling the user 204 to focus on processing the list elements once the user 204 has prioritized them.

The results of any operations performed by the system and method of FIGS. 13 and 14 may be propagated back to the native computer program(s) associated with elements in the list 102′, in any of the manners disclosed above in connection with propagation of other data. For example, changing the completion status of the selected list item to complete may be propagated back to the select list item's native computer program, so that the selected list item is marked as complete in the selected list item's native computer program. As another example, if the completion action that is performed on the selected list element is to move the selected list element to a particular folder, then the selected list element may be moved to the particular folder in the list element's native computer program.

Embodiments of the present invention have a variety of advantages, such as the following. One advantage of embodiments of the present invention is that various conventional techniques for automatic sorting (e.g., by date, time, subject, sender, category, folder, or tag/label) do not fit the needs of users in all situations. In particular, such conventional sorting techniques may provide a list order that is of general use to the user, but that does not order each and every list element in the order that is most useful to the user. For example, the user may apply an intuitive set of criteria to prioritize a list of activities, and the user may either not be capable of expressing those criteria in a form that can be used by a program to sort the list automatically according to those criteria (e.g., as a set of sort keys), or it might be prohibitively time-consuming for the user to define and input such criteria to a program, particular if such criteria change frequently and rapidly over time. This flaw in existing automatic sorting techniques is evidenced by the fact that users continue to use means outside of their native computer programs, such as word processing documents, spreadsheets, and even paper notes, to keep track of the actual order in which the user desires to attend to a set of activities, such as responding to emails, attending calendar appointments, and completing a set of tasks.

In contrast, embodiments of the present invention let the user apply his or her own intuitive criteria to prioritize a list of activities directly, quickly, and easily, simply by manually specifying the order of elements in the list. In particular, embodiments of the present invention enable the user to prioritize activities on a per-activity basis, meaning that the user may specify, for each element in a list of activities, a list position that is guaranteed to be unique relative to any other element in the list of activities. Such per-activity manual ordering includes per-activity manual ordering of activities of different types within the same list. For example, embodiments of the present invention enable the user to manually order a list containing two types of activities (e.g., email messages and calendar appointments) such that the list contains an element of the first activity type, followed immediately by an element of the second activity type, followed immediately by an element of the first activity type. As this example illustrates, embodiments of the present invention are not limited to grouping activities by activity type, native computer program, or in any other way. Rather, embodiments of the present invention enable the user to manually position any list element of any activity type and any native computer program at any position in the list relative to any other list element of any activity type and any native computer program.

In contrast, systems which allow the user to specify a temporal deadline or target completion time for a particular list element, such as “today” or “Feb. 1, 2013 at 05:00 AM,” do not guarantee that such identifiers represent a unique position in the list relative to other list elements. As the examples herein illustrate, the index that is associated with any particular element in a list does not (or at least need not) represent a time. Instead, such an index represents a position of the particular element relative to one or more other elements in the list. Such indices are more useful to users than times in situations in which the user's goal is to process list elements in a particular order, not to complete the processing of any particular list element by any particular time.

Yet another advantage of embodiments of the present invention is that they enable users to combine different types of activities (e.g., message activities, appointment activities, and task activities) into a single list that may be manually ordered and in which activities of any type may be marked by the user as complete. This represents an improvement over the common current practices employed by many users of using an email inbox, a calendar, and a task list as three separate lists of activities to be performed. In contrast, embodiments of the present invention enable users to maintain a single manually-sortable, actionable activity list, even if the native computer programs that created the underlying data elements do not provide manually sorting and/or completion of data elements.

Yet another advantage of embodiments of the present invention is that they may be used in connection with dynamic lists, such as an email inbox, to which additional elements are added while the user is processing the list. One reason that conventional email inboxes work particularly poorly as task lists is that such inboxes continue to receive new email messages while the user attempts to process existing email messages in the inbox with the goal of clearing the inbox of all email messages, especially because most users choose to sort their inboxes in reverse chronological order, thereby causing newly-received email messages to be inserted automatically at the top of the inbox, thereby breaking the user's concentration and increasing the likelihood that the user will process email messages in order of their receipt, rather than in order of their true importance to the user. One way in which embodiments of the present invention mitigate or avoid this problem is by enabling users to display a list in its manually sorted order, rather than in an automatically sorted order, such as in order of receipt date. Furthermore, new list elements (e.g., email messages) may automatically be inserted into the list below the list element with the lowest current manual sort order, thereby decreasing the likelihood that the user will be distracted by new list elements. Yet another way in which embodiments of the present invention mitigate or avoid this problem is by enabling manually-ordered lists to be displayed in a separate display area (e.g., window), thereby reducing likelihood that the addition of list elements to an automatically-sorted display area (e.g., the user's email inbox) will distract the user.

Yet another advantage of embodiments of the present invention is that they enable users to continue using their existing native computer programs if desired. For example, a user who prefers to use Microsoft Outlook to send and receive email may continue to do so when using embodiments of the present invention, because embodiments of the present invention may be implemented to interoperate with Microsoft Outlook using the techniques disclosed herein. Embodiments of the present invention, therefore, may be used to supplement, rather than replace, users' existing preferred native computer programs. As a result, users may obtain the benefits of manual ordering and activity completion without forfeiting the benefits of their existing preferred native computer programs.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below. With respect to any embodiments disclosed herein as modifications and/or additions to existing computer programs, those having ordinary skill in the art will appreciate how to implement such embodiments alternatively in systems which do not require such modifications and/or additions.

Although certain embodiments disclosed herein are described as modifications or additions to existing (e.g., native) computer programs, these are merely examples and do not constitute a limitation of the present invention. Embodiments of the present invention may, for example, be implemented as wholly standalone computer programs that do not require modifications to or communication with existing computer programs to perform the functions disclosed herein.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method performed by at least one computer processor executing computer program instructions stored on at least one non-transitory computer-readable medium, the method comprising:
(A) generating an original list containing a plurality of data elements, wherein the plurality of data elements includes:
a first data element of a first data type, wherein the first data type is one of a message data type, an appointment data type, and a task data type; and
a second data element of a second data type, wherein the second data type is one of the message data type, the appointment data type, and the task data type;
wherein the first and second data types differ from each other;
(B) receiving first ordering input from a user specifying: (1) a first particular data element, wherein the first particular data element comprises one of the first data element and the second data element; and (2) a first index;
(C) assigning the first index to the first particular data element in the original list, thereby producing a first modified list; and
(D) generating visual output representing the first modified list.

2. The method of claim 1, further comprising:
(E) receiving input from the user specifying that review of the first particular data element is complete; and
(F) in response to receiving the input from the user specifying that review of the first particular data element is complete:
(F)(1) storing, in association with the first particular data element, a data element specifying that review of the first particular data element is complete.

3. The method of claim 2, wherein (F) further comprises:
(F)(2) generating visual output representing the first modified list without generating visual output representing the first particular data element.

4. The method of claim 2, wherein (F) further comprises:
(F)(2) generating visual output representing the first modified list, including generating visual output representing the first particular data element and generating visual output indicating that review of the first particular data element is complete.

5. The method of claim 2, wherein (F) further comprises:
(F)(2) removing the particular data element from the first modified list to produce a second modified list; and
(F)(3) generating visual output representing the second modified list without generating visual output representing the first particular data element.

6. The method of claim 2, wherein (F) comprises creating the data element specifying that review of the first particular data element is complete.

7. The method of claim 2, wherein the input from the user specifying that review of the first particular data element is complete comprises input representing an instruction to close the first particular data element.

8. The method of claim 2, wherein the input from the user specifying that review of the first particular data element is complete comprises input representing an instruction to delete the first particular data element.

9. The method of claim 2, wherein the input from the user specifying that review of the first particular data element is complete comprises input representing an instruction to store the first particular data element in a list other than the original list and the first modified list.

10. The method of claim 2, wherein the first particular data element is of the message data type.

11. The method of claim 1, wherein generating the original list comprises:
receiving, from a first computer program, in response to first user selection input from the user, data representing the first data element; and
receiving, from a second computer program, in response to second user selection input from the user, data representing the second data element.

12. The method of claim 11:
wherein generating the original list further comprises receiving, from the first computer program, in response to third user selection input from the user, data representing a third data element of the first data type;
wherein the first modified list further contains the third data element; and
wherein the first modified list has an order in which the first data element is followed immediately by the second data element, and in which the second data element is followed immediately by the third data element.

13. The method of claim 1, wherein generating the original list comprises:
receiving, from a first computer program, in response to first user selection input from the user, data representing the first data element; and
receiving, from the first computer program, in response to second user selection input from the user, data representing the second data element.

14. The method of claim 1, further comprising:
(E) receiving second ordering input from the user specifying: (1) a second particular data element, wherein the second particular data element comprises one of the first data element and the second data element; and (2) a second index; wherein the second particular data element differs from the first particular data element;
(F) assigning the second index to the second particular data element in the first modified list, thereby producing a second modified list; and
(D) generating visual output representing the second modified list.

15. The method of claim 1:
wherein the first modified list further contains a third data element of the first data type; and
wherein the first modified list has an order in which the first data element is followed immediately by the second data element, and in which the second data element is followed immediately by the third data element.

16. The method of claim 1, wherein the first modified list has a first order specified by the first index and the second index, and wherein the method further comprises:
(E) storing a record of the first order.

17. The method of claim 16, further comprising:
(G) applying a sorting function to the first modified list to produce a second modified list having a second order that differs from the first order; and
(H) ordering the second modified list based on the record of the first order to produce a third modified list having a third order that is the same as the first order.

18. The method of claim 17, further comprising:
(I) after (G) and before (H), generating visual output representing the second modified list in the second order; and
(J) after (H), generating visual output representing the third modified list in the third order.

19. A system comprising at least one non-transitory computer-readable medium, the at least one non-transitory computer-readable medium comprising computer program instructions executable by at least one computer processor to perform a method, the method comprising:
(A) generating an original list containing a plurality of data elements, wherein the plurality of data elements includes:
a first data element of a first data type, wherein the first data type is one of a message data type, an appointment data type, and a task data type; and
a second data element of a second data type, wherein the second data type is one of the message data type, the appointment data type, and the task data type;
wherein the first and second data types differ from each other;
(B) receiving first ordering input from a user specifying: (1) a first particular data element, wherein the first particular data element comprises one of the first data element and the second data element; and (2) a first index;
(C) assigning the first index to the first particular data element in the original list, thereby producing a first modified list; and
(D) generating visual output representing the first modified list.

20. The system of claim 19, wherein the method further comprises:
(E) receiving input from the user specifying that review of the first particular data element is complete; and
(F) in response to receiving the input from the user specifying that review of the first particular data element is complete:
(F)(1) storing, in association with the first particular data element, a data element specifying that review of the first particular data element is complete.

21. The system of claim 20, wherein (F) further comprises:
(F)(2) generating visual output representing the first modified list without generating visual output representing the first particular data element.

22. The system of claim 20, wherein (F) further comprises:
(F)(2) generating visual output representing the first modified list, including generating visual output representing the first particular data element and generating visual output indicating that review of the first particular data element is complete.

23. The system of claim 20, wherein (F) further comprises:
(F)(2) removing the particular data element from the first modified list to produce a second modified list; and
(F)(3) generating visual output representing the second modified list without generating visual output representing the first particular data element.

24. The system of claim 20, wherein (F) comprises creating the data element specifying that review of the first particular data element is complete.

25. The system of claim 20, wherein the input from the user specifying that review of the first particular data element is complete comprises input representing an instruction to close the first particular data element.

26. The system of claim 20, wherein the input from the user specifying that review of the first particular data element is complete comprises input representing an instruction to delete the first particular data element.

27. The system of claim 20, wherein the input from the user specifying that review of the first particular data element is complete comprises input representing an instruction to store the first particular data element in a list other than the original list and the first modified list.

28. The system of claim 20, wherein the first particular data element is of the message data type.

29. The system of claim 19, wherein generating the original list comprises:
receiving, from a first computer program, in response to first user selection input from the user, data representing the first data element; and
receiving, from a second computer program, in response to second user selection input from the user, data representing the second data element.

30. The system of claim 29:
wherein generating the original list further comprises receiving, from the first computer program, in response to third user selection input from the user, data representing a third data element of the first data type;
wherein the first modified list further contains the third data element; and
wherein the first modified list has an order in which the first data element is followed immediately by the second data element, and in which the second data element is followed immediately by the third data element.

31. The system of claim 19, wherein generating the original list comprises:
receiving, from a first computer program, in response to first user selection input from the user, data representing the first data element; and
receiving, from the first computer program, in response to second user selection input from the user, data representing the second data element.

32. The system of claim 19, wherein the method further comprises:
(E) receiving second ordering input from the user specifying: (1) a second particular data element, wherein the second particular data element comprises one of the first data element and the second data element; and (2) a second index; wherein the second particular data element differs from the first particular data element;
(F) assigning the second index to the second particular data element in the first modified list, thereby producing a second modified list; and
(D) generating visual output representing the second modified list.

33. The system of claim 19:
wherein the first modified list further contains a third data element of the first data type; and
wherein the first modified list has an order in which the first data element is followed immediately by the second data element, and in which the second data element is followed immediately by the third data element.

34. The system of claim 19, wherein the first modified list has a first order specified by the first index and the second index, and wherein the method further comprises:
(E) storing a record of the first order.

35. The system of claim 34, wherein the method further comprises:
(G) applying a sorting function to the first modified list to produce a second modified list having a second order that differs from the first order; and
(H) ordering the second modified list based on the record of the first order to produce a third modified list having a third order that is the same as the first order.

36. The system of claim 35, wherein the method further comprises:
(I) after (G) and before (H), generating visual output representing the second modified list in the second order; and
(J) after (H), generating visual output representing the third modified list in the third order.
